(19) United States
(12) Patent Application Publication
(10) Pub. No.: US 2021/0390828 A1
(43) Pub. Date: Dec. 16, 2021

(54) Architectures for Mobile Wallet and Other Electronic Payment Operations in a Gaming Environment

(71) Applicant: JCM American Corporation, Las Vegas, NY (US)

(72) Inventors: Dave Kubajak, Las Vegas, NV (US); Mike Nguyen, Las Vegas, NV (US); Edwin Lai, Las Vegas, NV (US); Emmanuel Sanchez, Las Vegas, NV (US); Mark Castilo, Las Vegas, NV (US)

(21) Appl. No.: 16/899,417

(22) Filed: Jun. 11, 2020

(51) Int. Cl. G07F 17/32; G06Q 20/04; G06Q 20/36; G06Q 20/32

(52) U.S. Cl. CPC G07F 17/3251; G07F 17/3223; G06Q 20/3223; G06Q 20/36; G06Q 20/04

(57) ABSTRACT

A system for electronic payment operations in a gaming environment includes a peripheral system, a peripheral network adapter associated with an electronic gaming machine, and a wireless interface (such as a standalone device, a component of the peripheral network adapter, and/or other device operable to perform functions such as interfacing with a user's phone, payment card, or the like). In some examples, the system may receive payment information from one or more mobile devices; communicate with a payment processing system to process a payment when the payment information relates to a card payment transaction or a mobile payment transaction; communicate with a player wallet system to process the payment when the payment information relates to a player wallet system transaction; and credit the electronic gaming machine. In various examples, the system may credit the electronic gaming machine by sending TITO ticket data to a bill validator associated with the electronic gaming machine, by sending an automated funds transfer to the electronic gaming machine, by having a casino management server and/or system credit the electronic gaming machine, and so on.

### FIELD

The described embodiments relate generally to mobile wallet and other electronic payment (such as card payments, contactless payments, and so on) operations. More particularly, the present embodiments relate to architectures for mobile wallet and other electronic payment (such as card payments, contactless payments, and so on) and/or other operations in a gaming environment.

### BACKGROUND

A gaming industry entity, such as a casino, may be involved with a variety of different cash and/or cashless transactions (e.g., ticket in/ticket out (“TITO”) transactions, player card transactions, credit card transactions, (such as Apple Pay™, Google Pay™, iTITO wallets, or the like) and so on) initiated by, through, or associated with an electronic gaming machine controlled by that entity. How such transactions may be processed may be restricted by the regulatory body and/or the limitations of the equipment and/or software associated with the electronic gaming machine.

For example, an electronic gaming machine may be associated with a bill validator that is operable to receive cash or other currency, tickets, and so on and credit the value received to the electronic gaming machine. By way of another example, an electronic gaming machine may automatically debit a player account associated with a player card when that card is inserted into a player card reader associated with the electronic gaming machine.

Incorporating new or additional features may typically require expensive total replacement of electronic gaming machines with newer machines. Furthermore, typically once approved by an appropriate regulatory body, transaction hardware and/or software associated with an electronic gaming machine cannot be modified to incorporate new or additional features without undergoing an expensive and time-consuming re-approval process conducted by, or under the authority of, the regulatory body.

### SUMMARY

The present disclosure relates to architectures for mobile wallet and other electronic operations in a gaming environment. A system for mobile wallet operations in a gaming environment includes a peripheral system, a peripheral network adapter associated with an electronic gaming machine, and a wireless interface (such as a standalone device, a component of the peripheral network adapter, and/or other device operable to perform functions such as interfacing with a user's phone, payment card, or the like). In some examples, the system may receive payment information from one or more mobile devices; communicate with a payment processing system to process a payment when the payment information relates to a card payment transaction or a mobile payment transaction; communicate with a player wallet system to process the payment when the payment information relates to a player wallet system transaction; and credit the electronic gaming machine. In various examples, the system may credit the electronic gaming machine by sending TITO ticket data to a bill validator associated with the electronic gaming machine, by sending an automated funds transfer to the electronic gaming machine, by having a casino management server and/or system credit the electronic gaming machine, and so on.

In various embodiments, a system for electronic payment operations in a gaming environment includes an electronic gaming machine, a bill validator associated with the electronic gaming machine, a peripheral network adapter that is associated with the electronic gaming machine and configured to wirelessly receive payment information from at least one mobile device, and a peripheral system. The peripheral system is configured to: receive the payment information from the peripheral network adapter; when the payment information relates to a card payment transaction or a mobile payment transaction, communicate with a payment processing system to process a payment; when the payment information relates to a player wallet system transaction, communicate with a player wallet system to process the payment; and upon processing of the payment, send ticket in/ticket out (TITO) ticket data to the peripheral network adapter obtained from a TITO system. The peripheral network adapter sends the TITO ticket data to the bill validator to credit the electronic gaming machine.

In some examples, the peripheral system determines whether the payment information relates to the card payment transaction, the mobile payment transaction, or the player wallet system transaction. In various examples, the peripheral system is configured to pair the at least one mobile device with at least one of the peripheral network adapter or the electronic gaming machine using pairing information received by the peripheral network adapter from the at least one mobile device.

In a number of examples, the peripheral system processes the payment for a preset amount. In some examples, the peripheral system processes the payment for an amount specified via the at least one mobile device. In various examples, the peripheral system processes the payment for an amount specified via a player interface device associated with the electronic gaming machine. In a number of implementations of such examples, the peripheral system receives the amount specified via the player interface device from the peripheral network adapter. The peripheral system may receive the amount specified via the player interface device from the peripheral network adapter, directly from the player interface device, and so on. The player interface device may be a keypad, a tablet device, a terminal, and/or any kind of device that a user may use to input the amount.

In some embodiments, a system for electronic payment operations in a gaming environment includes an electronic gaming machine, a bill validator associated with the electronic gaming machine, a peripheral system, and a peripheral network adapter. The peripheral network adapter is associated with the electronic gaming machine and configured to: wirelessly receive payment information from at least one mobile device; when the payment information relates to a card payment transaction or a mobile payment transaction, communicate with a payment processing system to process a payment; when the payment information relates to a player wallet system transaction, communicate with a player wallet system to process the payment; upon processing of the payment, obtain ticket in/ticket out (TITO) ticket data from a TITO system via the peripheral system; and send the TITO ticket data to the bill validator to credit the electronic gaming machine.

In various examples, the at least one mobile device is a first mobile device and a second mobile device. In some implementations of such examples, the first mobile device is a payment card and the second mobile device is at least one of a mobile phone, a tablet computing device, a laptop computing device, a wearable device, or a smart watch. In some such configurations, the peripheral network adapter wirelessly receives the payment information from the payment card. In other such configurations, the peripheral network adapter wirelessly receives the payment information from the payment card via the second mobile device.

In some examples, at least one of the player wallet system stores funds in one or more currencies and/or forms and the peripheral network adapter obtains information regarding the funds via the player wallet system or the TITO ticket data is stored in the player wallet system and at least one of the peripheral system or the peripheral network adapter obtains the TITO ticket data from the TITO system via the player wallet system. In various examples, the peripheral network adapter determines whether the payment information relates to the card payment transaction, the mobile payment transaction, or the player wallet system transaction.

In a number of embodiments, a system for electronic payment operations in a gaming environment includes an electronic gaming machine and a peripheral network adapter. The peripheral network adapter is associated with the electronic gaming machine and configured to: wirelessly receive payment information from at least one mobile device; when the payment information relates to a card payment transaction or a mobile payment transaction, communicate with a payment processing system to process a payment; when the payment information relates to a player wallet system transaction, communicate with a player wallet system to process the payment; and upon processing of the payment, credit the electronic gaming machine.

In various examples, the peripheral network adapter communicates with the payment processing system via a peripheral system. In some examples, the peripheral network adapter communicates with the player wallet system via a peripheral system. In a number of examples, the peripheral network adapter requests permission from a peripheral system before processing the payment.

In some examples, the peripheral network adapter credits the electronic gaming machine using an automated funds transfer. In various examples, the peripheral network adapter credits the electronic gaming machine by at least one of communicating with a casino management system via a peripheral system, communicating directly with communicating with the casino management system, or by sending TITO ticket data to a bill validator.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example system for electronic payment operations in a gaming environment.

FIG. 2 depicts a first example data flow for mobile wallet operations in a gaming environment. The data flow may be implemented using the system of FIG. 1.

FIG. 3 depicts a second example data flow for mobile wallet operations in a gaming environment. The data flow may be implemented using the system of FIG. 1.

FIG. 4 depicts a third example data flow for mobile wallet operations in a gaming environment. The data flow may be implemented using the system of FIG. 1.

FIG. 5 depicts a fourth example data flow for mobile wallet operations in a gaming environment. The data flow may be implemented using the system of FIG. 1.

FIG. 6 depicts a fifth example data flow for mobile wallet operations in a gaming environment. The data flow may be implemented using the system of FIG. 1.

FIG. 7 depicts a sixth example data flow for mobile wallet operations in a gaming environment. The data flow may be implemented using the system of FIG. 1.

FIG. 8 depicts a seventh example data flow for mobile wallet operations in a gaming environment. The data flow may be implemented using the system of FIG. 1.

FIG. 9 depicts an eighth example data flow for mobile wallet operations in a gaming environment. The data flow may be implemented using the system of FIG. 1.

FIG. 10 depicts a ninth example data flow for mobile wallet operations in a gaming environment. The data flow may be implemented using the system of FIG. 1.

FIG. 11 depicts a tenth example data flow for mobile wallet operations in a gaming environment. The data flow may be implemented using the system of FIG. 1.

FIG. 12 depicts an eleventh example data flow for mobile wallet operations in a gaming environment. The data flow may be implemented using the system of FIG. 1.

FIG. 13 depicts a twelfth example data flow for mobile wallet operations in a gaming environment. The data flow may be implemented using the system of FIG. 1.

FIG. 14 depicts a thirteenth example data flow for mobile wallet operations in a gaming environment. The data flow may be implemented using the system of FIG. 1.

FIG. 15 depicts a fourteenth example data flow for mobile wallet operations in a gaming environment. The data flow may be implemented using the system of FIG. 1.

FIG. 16 depicts a fifteenth example data flow for mobile wallet operations in a gaming environment. The data flow may be implemented using the system of FIG. 1.

FIG. 17 depicts a sixteenth example data flow for mobile wallet operations in a gaming environment. The data flow may be implemented using the system of FIG. 1.

FIG. 18 depicts a seventeenth example data flow for mobile wallet operations in a gaming environment. The data flow may be implemented using the system of FIG. 1.

FIG. 19 depicts an eighteenth example data flow for mobile wallet operations in a gaming environment. The data flow may be implemented using the system of FIG. 1.

FIG. 20 depicts a nineteenth example data flow for mobile wallet operations in a gaming environment. The data flow may be implemented using the system of FIG. 1.

FIG. 21 depicts a twentieth example data flow for mobile wallet operations in a gaming environment. The data flow may be implemented using the system of FIG. 1.

FIG. 22 depicts a twenty-first example data flow for mobile wallet operations in a gaming environment. The data flow may be implemented using the system of FIG. 1.

FIG. 23 depicts a twenty-second example data flow for mobile wallet operations in a gaming environment. The data flow may be implemented using the system of FIG. 1.

FIG. 24 depicts a first example of a game-crediting process that may be used in mobile wallet operations in a gaming environment. The game-crediting process may be used in one or more of the data flows of FIGS. 2-23. The game-crediting process may be performed using the system of FIG. 1.

FIG. 25 depicts a second example of a game-crediting process that may be used in mobile wallet operations in a gaming environment. The game-crediting process may be used in one or more of the data flows of FIGS. 2-23. The game-crediting process may be performed using the system of FIG. 1.

FIG. 26 depicts a third example of a game-crediting process that may be used in mobile wallet operations in a gaming environment. The game-crediting process may be used in one or more of the data flows of FIGS. 2-23. The game-crediting process may be performed using the system of FIG. 1.

FIG. 27 depicts a fourth example of a game-crediting process that may be used in mobile wallet operations in a gaming environment. The game-crediting process may be used in one or more of the data flows of FIGS. 2-23. The game-crediting process may be performed using the system of FIG. 1.

FIG. 28 depicts a fifth example of a game-crediting process that may be used in mobile wallet operations in a gaming environment. The game-crediting process may be used in one or more of the data flows of FIGS. 2-23. The game-crediting process may be performed using the system of FIG. 1.

FIG. 29 depicts a sixth example of a game-crediting process that may be used in mobile wallet operations in a gaming environment. The game-crediting process may be used in one or more of the data flows of FIGS. 2-23. The game-crediting process may be performed using the system of FIG. 1.

FIG. 30 depicts a seventh example of a game-crediting process that may be used in mobile wallet operations in a gaming environment. The game-crediting process may be used in one or more of the data flows of FIGS. 2-23. The game-crediting process may be performed using the system of FIG. 1.

FIG. 31 depicts an eighth example of a game-crediting process that may be used in mobile wallet operations in a gaming environment. The game-crediting process may be used in one or more of the data flows of FIGS. 2-23. The game-crediting process may be performed using the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Some embodiments described herein reference architectures for mobile wallet and other electronic operations in a gaming and/or other environments. This may involve a variety of transactions, such as cash-outs, redemptions, and/or promotions initiated involving, processed involving, or associated with an electronic gaming machine (e.g., slot machine, video poker machine, keno machine, and the like) under the control of a gaming industry entity (e.g., a casino or other wagering, gaming, or lottery environment) without requiring modification of—and/or integration with—game machine processing units or existing accounting or computer network systems implemented by a gaming industry entity.

More specifically, embodiments described herein reference architectures for mobile wallet and other electronic operations in a gaming and/or other environments in which a “user” (also referred to as a patron, customer, player, and so on) of an electronic gaming machine in a casino may provide identifying information to the electronic gaming machine by authorizing communication of identity information from a mobile device under the control of the player to various hardware and/or software installed in the same cabinet as, or otherwise associated with, the electronic gaming machine.

In this manner, a user may use the mobile device to facilitate interactions with an electronic gaming machine (e.g., gameplay funded from a player's account, mobile wallet account, payment card, and so on) without requiring the player to keep, carry, or present gameplay vouchers (e.g., TITO vouchers, player cards, and so on), cash, or other cashless tokens to the electronic gaming machine. As a result of this construction, a player may begin gameplay faster, may cash-out faster, and may receive promotions or coupons provided by the casino on their mobile device, whether or not the player is currently interacting with an electronic gaming machine. Additionally, an electronic gaming machine, such as described herein, can optionally be manufactured without and/or use less frequently possibly redundant components that may be subject to mechanical failure, such as TITO mechanisms, voucher printers, bill validators, and so on. As a result, such electronic gaming machines may exhibit improved reliability and uptime over the life of the machine.

Continuing the example introduced above, in many embodiments, an application executed by a mobile device of a player facilitates wireless communication (using one or more standardized or proprietary wireless communication protocols) with a wireless interface associated with an electronic gaming machine in order to establish a communication channel (whether secured or unsecured) between the mobile device and the wireless interface and/or other component. Thereafter, the mobile device and the wireless interface and/or other component may exchange information. Example wireless communication protocols include, but are not limited to: Wi-Fi, Bluetooth™, Bluetooth™ Low Energy (“BLE”), near-field communication (“NFC”), infrared, optical communication, cellular communication, acoustic communication, image-based communication, fiducial markers for image processing, and so on.

In other examples, the mobile device may be directly and/or conductively coupled to a component associated with the electronic gaming machine (e.g., via cable or dock) in order to establish a communication channel between the mobile device and the component.

In these examples, as noted above, once a communication channel is established, the mobile device may transmit or otherwise convey any suitable information to the wireless interface and/or other component associated with the electronic gaming machine. Such information may include, but is not limited to: a user's identity information (e.g., name, date of birth, gender, biometric information, and so on), a user's financial information (e.g., account numbers, account identifiers, routing numbers, credit card numbers, player account information), a user's preference or historical information (e.g., player history, gameplay history, player preferences, and so on), data from one or more sensors of the mobile device (e.g., temperature, camera data, microphone data, and so on), and so on.

In response, in one embodiment, the wireless interface and/or other component associated with the electronic gaming machine may communicate with a local or remote server that maintains a mobile wallet or other account associated with the user. If the user's account balance exceeds a minimum threshold level necessary to enable gameplay on the electronic gaming machine, the local or remote server may send a signal to issue gameplay credit, allowing the player to play a game presented by the electronic gaming machine.

Phrased in another, non-limiting, manner, these embodiments may substitute and/or supplement conventional cash, TITOs, player cards, and/or other conventional systems and methods of enabling cashless interactions between a player and an electronic gaming machine in a casino environment. As a result of this construction, as noted above, an electronic gaming machine can be operated and/or constructed with fewer and/or use less frequently possibly redundant components that may be subject to mechanical failure (e.g., bill validators, printers, card readers, and so on), thereby increasing the reliability and uptime of the electronic gaming machine. In addition, as a result of this construction, a user may benefit from increased control and authority over cashless transactions performed using, facilitated by, and/or otherwise involving electronic gaming machines in a casino environment.

For simplicity of description, many embodiments herein reference a “casino” as an example gaming industry entity, although it is appreciated that this is merely one example. Similarly, for simplicity of description, the phrase “electronic gaming machine” as used herein is generally understood to refer to a stationary slot machine within a casino, however, it may be understood that this is merely one example of an electronic gaming machine. In other words, in some embodiments, other gaming industry entities and/or other stationary, portable, and/or digital (e.g., software-based) electronic gaming machines and/or services may be suitable for use with the various embodiments described herein and equivalents thereof.

The phrase “mobile device” and equivalents as used herein refers to any electronic device under the control of a user in a casino and/or other environment, whether that device is owned and operated by the casino (e.g., and lent to the user while the user is in the casino) or by a particular user. Example mobile devices may include, but are not limited to: cell phones, tablet computing devices, laptop computing, smart watches, smart wrist bands, smart cards, payment cards (such as credit cards, player cards, debit cards, and so on, implantable smart chips, personal digital assistants, digital media players, wearable devices, wireless paging system pagers, key fobs, wireless enabled accessory devices (e.g., headphones, health monitors, and so on), and so on.

Components of a mobile device, such as described herein, may include, but are not necessarily limited to, one or more of a processor, a memory, a power supply, one or more sensors, one or more communication interfaces, one or more data connectors, one or more power connectors, one or more input/output devices, such as a speaker, a rotary input device, a microphone, an on/off button, a mute button, a biometric sensor, a camera, a force and/or touch sensitive trackpad, and so on.

The personal electronic device may include a display. The display may be implemented with any suitable technology, including, but not limited to, a multi-touch and/or multi-force sensing touchscreen that uses liquid crystal display technology, light-emitting diode technology, organic light-emitting display technology, organic electroluminescence technology, electronic ink, or another type of display technology or combination of display technology types.

In many embodiments, one or more components of the mobile device may include or can be communicably coupled to circuitry and/or logic components, such as a processor and a memory. The processor of the mobile device may be implemented as any mobile device capable of processing, receiving, or transmitting data or instructions. For example, the processor may be a microprocessor, a central processing unit, an application-specific integrated circuit, a field-programmable gate array, a digital signal processor, an analog circuit, a digital circuit, or combination of such devices. The processor may be a single-thread or multi-thread processor. The processor may be a single-core or multi-core processor.

Accordingly, as described herein, the phrase “processing unit” or, more generally, “processor” may refer to a hardware-implemented data processing device or circuit physically structured to execute specific transformations of data including data operations represented as code and/or instructions included in a program that can be stored within and accessed from a memory. The term is meant to encompass a single processor or processing unit, multiple processors, multiple processing units, analog or digital circuits, or other suitably configured computing element or combination of elements.

Still further embodiments described herein reference systems, methods, apparatuses, and computer program products involving transactions performed in a casino and/or environment with particular electronic gaming machines and particular users. More broadly, these embodiments reference architectures for mobile wallet and other electronic operations in gaming and/or other environments.

The following disclosure relates to architectures for mobile wallet and other electronic operations in a gaming environment. A system for mobile wallet operations in a gaming environment includes a peripheral system, a peripheral network adapter associated with an electronic gaming machine, and a wireless interface (such as a standalone device, a component of the peripheral network adapter, and/or other device operable to perform functions such as interfacing with a user's phone, payment card, or the like). In some examples, the system may receive payment information from one or more mobile devices; communicate with a payment processing system to process a payment when the payment information relates to a card payment transaction or a mobile payment transaction; communicate with a player wallet system to process the payment when the payment information relates to a player wallet system transaction; and credit the electronic gaming machine. In various examples, the system may credit the electronic gaming machine by sending TITO ticket data to a bill validator associated with the electronic gaming machine, by sending an automated funds transfer to the electronic gaming machine, by having a casino management server and/or system credit the electronic gaming machine, and so on.

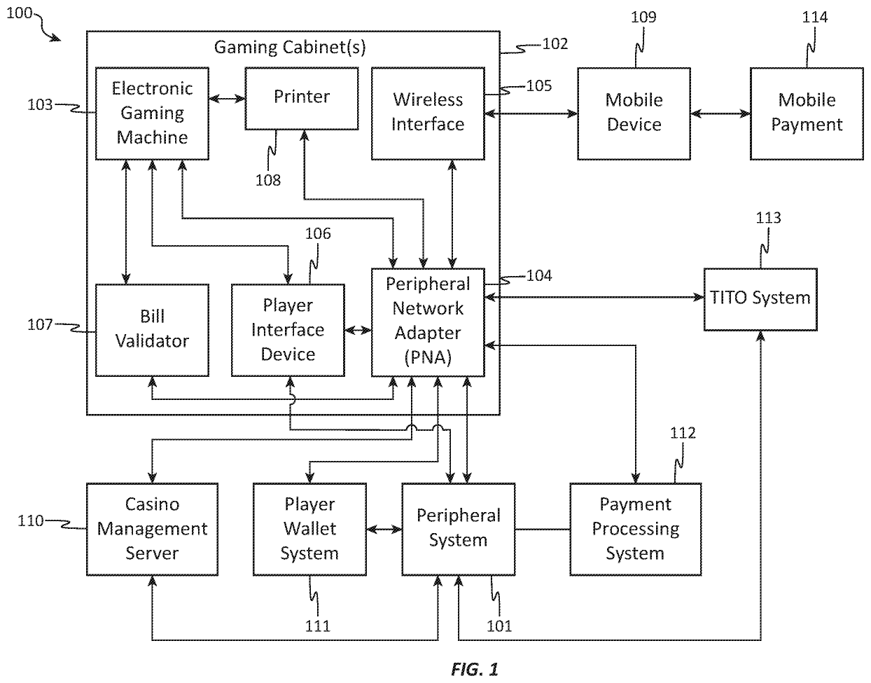

These and other embodiments are discussed below with reference to FIGS. 1-31. However, those skilled in the art will readily appreciate that the detailed description given herein with respect to these Figures is for explanatory purposes only and should not be construed as limiting.

Generally and broadly, FIG. 1 depicts a simplified diagram of a casino environment including an electronic gaming machine, a mobile device, and architectures for mobile wallet and other electronic operations in gaming and/or other environments such as described herein. These elements, among others, are discussed in greater detail below.

FIG. 1 depicts an example system 100 for mobile wallet operations in a gaming environment. The system 100 may include one or more electronic gaming machines 103 (which may be located in one or more gaming cabinets 102 with and/or otherwise associated with one or more peripheral network adapters (PNA) 104, wireless interfaces 105, player interface devices 106, printers, bill validators 107, and so on), mobile devices 109, casino management servers 110 and/or systems, player wallet systems 111, peripheral systems 101, payment processing systems 112, TITO systems 113, mobile payment 114 systems, and so on. Various of these components of the system 100 may be configured in various embodiments to communicate with each other in one or more architectures for mobile wallet and other electronic operations.

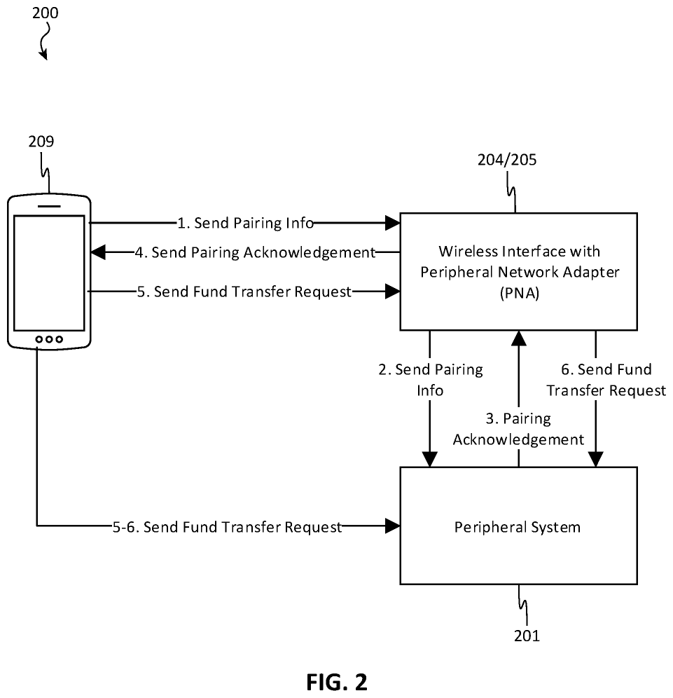

For example, the electronic gaming machine 103 may be operable to interact with and/or control the player interface device 106, the printer 108, the bill validator 107, and so on to perform various functions, such as facilitating game play for a user, performing one or more cash-in operations, perform one or more cash-out operations, and so on. The peripheral network adapter (PNA) 104 may also be communicably connected to one or more of these components and be operable to instruct and/or control operation of one or more of these components on behalf of one or more other servers or systems without interacting with the electronic gaming machine 103. Such servers or systems may include one or more of the mobile device 109 (via the mobile device 109) and/or the mobile payment 114 system (via the mobile device 109 and the wireless interface 105), the casino management server 110 and/or system, the player wallet system 111, the peripheral system 101, the payment processing system 112, the TITO system 113, and so on. One or more of these other components may also be configured to communicate with each other to perform various functions. For example, the peripheral system 101 may be configured to communicate with one or more of the casino management server 110 and/or system, the player wallet system 111, the payment processing system 112, the TITO system 113, and so on (whether directly, via one or more wired and/or wireless communication networks, and so on). This will be described in detail with reference to FIGS. 2-31 below.

In some examples, the system 100 may receive payment information from one or more mobile devices 109; communicate with a payment processing system 112 to process a payment when the payment information relates to a card payment transaction or a mobile payment transaction; communicate with a player wallet system 111 to process the payment when the payment information relates to a player wallet system transaction; and credit the electronic gaming machine 103. In various examples, the system 100 may credit the electronic gaming machine 103 by sending TITO ticket data (i.e., a digital representation of a TITO ticket and/or other digital file including information associated with a physical and/or virtual TITO ticket) to a bill validator associated with the electronic gaming machine 103, by sending an automated funds transfer to the electronic gaming machine 103, by having a casino management server 110 and/or system 110 credit the electronic gaming machine 103, and so on.

In various implementations, the peripheral network adapter (PNA) 104 may be configured to wirelessly receive payment information from at least one mobile device 109 and the peripheral system 101 may be configured to: receive the payment information from the peripheral network adapter (PNA) 104; when the payment information relates to a card payment transaction or a mobile payment transaction, communicate with the payment processing system 112 to process a payment; when the payment information relates to a player wallet system transaction, communicate with the player wallet system 111 to process the payment; and upon processing of the payment, send TITO ticket data to the peripheral network adapter (PNA) 104 obtained from the TITO system 113. The peripheral network adapter (PNA) 104 may send the ticket to the bill validator 107 to credit the electronic gaming machine 103.

In some implementations, the peripheral network adapter (PNA) 104 may be configured to: wirelessly receive payment information from at least one mobile device 109; when the payment information relates to a card payment transaction or a mobile payment transaction, communicate with the payment processing system 112 to process a payment; when the payment information relates to a player wallet system transaction, communicate with the player wallet system 111 to process the payment; upon processing of the payment, obtain a TITO from the TITO system 113 via the peripheral system 101; and send the ticket to the bill validator 107 to credit the electronic gaming machine 103.

In a number of implementations, the peripheral network adapter (PNA) 104 may be configured to: wirelessly receive payment information from at least one mobile device 109; when the payment information relates to a card payment transaction or a mobile payment transaction, communicate with the payment processing system 112 to process a payment; when the payment information relates to a player wallet system transaction, communicate with the player wallet system 111 to process the payment; and upon processing of the payment, credit the electronic gaming machine 103. The peripheral network adapter (PNA) 104 may communicate with the payment processing system 112 and/or the player wallet system 111 via the peripheral system 101, request permission from the peripheral system 101 before processing the payment, and so on. The peripheral network adapter (PNA) 104 may credit the electronic gaming machine 103 using an automated funds transfer (AFT), by communicating with a casino management server 110 and/or system via the peripheral system 101, and so on.

In the scope of the present disclosure, a bill validator 107 may be a device associated with the electronic gaming machine 103 that may validate and store currency, TITO tickets, and so on. A player interface device may be a device mounted on, in, near, and/or otherwise associated with the electronic gaming machine 103 or a kiosk or other device that allows a user to interface with the electronic gaming machine 103 or other device for the purpose of transferring credits, tickets, and so on to or from the electronic gaming machine 103 or other device.

The peripheral network adapter (PNA) 104 may be a small processing unit associated with the electronic gaming machine 103 that may connect to one or more peripherals and to a network in order to allow those peripherals to be part of a larger system and to enable operation, such as transferring credit to or from an electronic gaming machine 103 or other device. The peripheral network adapter (PNA) 104 is shown as a unique device. However, it is understood that this is an example. In some implementations, another device (such as the bill validator 107, the printer 108 (which may be a ticket printer), a bezel for the bill validator 107, a bezel for the printer 108, the player interface device 106, and/or other device could be both itself and the peripheral network adapter (PNA) 104.

The TITO system 113 may be a service or system in a casino that may be used to issue, validate, and/or redeem TITO tickets, TITO ticket data, and/or TITO ticket validation numbers. In some cases, the TITO tickets may be iTITO tickets, TITO ticket data, and/or other virtual TITO tickets stored in the player wallet system 111. These iTITO tickets may be viewed and redeemed from the mobile device 109.

The peripheral system 101 may be a service or system available within the casino network and/or an expanded network that may be used to drive transactions involving casino peripherals. Such casino peripherals may include the bill validator 107, the printer 108 (which may be a TITO ticket printer), the player interface device 106, and/or any other peripheral (such as a peripheral used as a middleman to connect other peripherals).

The player wallet system 111 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. In such examples, the mobile device may use Wi-Fi, cellular, Bluetooth™, and/or other network and/or communication technology to contact the player wallet system and retrieve the user's account information.

The casino management server 110 or system maybe a service or system available inside a casino network that may store and drive electronic gaming machine 103 and user activity.

The payment processing system 112 may be a system that may authenticate and actually process payment transactions performed using credit cards, debit cards, other financial accounts, and/or mobile payment 114 services.

The mobile payment 114 system may be a contactless payment and/or other mobile payment service. Examples of such contactless payment and/or other mobile payment services may include, but are not limited to, Apple Pay™, Google Pay™, and so on. Such contactless payment and/or other mobile payment services may involve using the mobile device 109 to communicate with the respective mobile payment 114 service, receiving information associated with a payment that is ready for use, and wirelessly and/or otherwise providing that information received from the mobile payment 114 service to complete the payment.

As discussed herein, the user's mobile device 109 or devices may enable contactless transactions through the use of one or more wireless technologies. Such technologies may include NFC, Bluetooth™, BLE, Wi-Fi, a cellular network (such as CDMA, EDGE, 2G, 3G, 4G, 4G-LTE, 5G, and so on), RFID (“radio-frequency identification”), and so on. For example, a user may “tap” or “bump” the mobile device 109 to connect the mobile device 109 to a NFC antenna. In some examples, the mobile device 109 may be paired with the wireless interface 105 and/or another device.

The mobile device 109 may receive pairing information for wireless communication via one or more different representations that may be transferred one or more ways, such as via a barcode, numeric and/or text optical character recognition, and so on. In the context of the present application, barcodes may refer to 1D barcodes (such as Code 39, ITF, and so on), 2D barcodes (such as QR code, Data Matrix, and so on), and so on.

In some examples discussed herein, a user may transfer funds to and/or from an electronic gaming machine 103 via a mobile device 109 that is a credit card or other payment card. Where card payments are discussed herein, the following other devices may also be used instead: debit cards, casino players cards, cards from major payment networks (such as Visa™ MasterCard™, and so on), smart cards (such as contact smart cards, contactless smart cards, hybrid cards that have both contact and contactless mechanisms, USB, and so on). Card information may be read and/or otherwise obtained through a contactless means, such as NFC, RFID, camera, and so on and/or through contact, such as magnetic stripe, smart chip, and so on.

As discussed herein, a user may transfer funds to and/or from the electronic gaming machine 103 using a mobile wallet via the player wallet system 111 and/or the mobile payment 114 system. Mobile wallet (which may also be referred to as mobile money, mobile money transfer, mobile payment, and so on) may generally refer to payment services operated under financial regulation and performed from or via the mobile device 109. Where mobile wallets are discussed herein, the following other methods may be used: mobile payment 114 systems, card-based payments, carrier billing, contactless payments, direct transfers between payer and casino bank accounts, QR code payments, cloud-based mobile payments, audio signal-based payments, direct carrier/bank co-operation, bank transfer systems, cryptocurrency wallets, digital wallets, and so on.

The wireless interface 105 may be associated with an interface device associated with the electronic gaming machine 103. This interface device may be an NFC, Bluetooth, and/or other wireless enabled device mounted to and/or otherwise associated with the electronic gaming machine 103; the bill validator 107 and/or a bezel thereof, the printer 108 and/or a bezel thereof, a card reader and/or bezel thereof, a button, a non-pushable button, a candle (an indicator light often associated with electronic gaming machines 103 that may indicate statuses and/or other information), a device mounted next to and/or otherwise associated with the electronic gaming machine 103 (such as protruding from the gaming cabinet 102, coupled to the gaming cabinet 102, recessed into the gaming cabinet 102, and so on.

The player interface 106 may be any kind of device that allows a user to interface with the electronic gaming machine 103 and/or associated components. This may include, but is not limited to a touch screen, a display, a button, a keypad, the interface device described above associated with the wireless interface 105, and/or other user interface device. In some implementations, the player interface 106 may be a standalone device, such as a tablet computing device, a service window, and so on where a user may be able to input payment information.

As noted above, a casino operator (herein, more broadly, a “gaming industry entity”) typically provides numerous electronic devices on casino floors and elsewhere that may be involved in one or more transactions with one or more users. Examples of such electronic devices include electronic gaming machines, point-of-sale terminals, electronic table games, and so on.

More specifically, casino operators facilitate transactions involving “cash” and its equivalents, where “cash” collectively herein refers to any form of financial consideration, such as currency bills issued by a governmental entity, bank credits, house credits, pre-paid local or remote accounts, and any other form of transferrable denominations of financial value and/or denominations that may be exchanged for denominations of financial value, whether inside the casino or elsewhere.

To facilitate transactions between users and casino operators and/or other system 100 components, conventional casino operators often encourage users to utilize casino-issued “cards” or paper vouchers, typically referred to as “TITO” cards or paper voucher/receipts. A TITO card essentially identifies a user (e.g., by displaying/printing the player's name on the card) and associates a given “point” value with the user. Typically, the point value may also be stored in a casino accounting system in a “player account” that associates the user's name and identity information with all vouchers and points credited to that user. The user may attempt to limit access and use of a TITO card, however, in a conventional casino environment, any person in possession of the player's TITO card may be able to transfer value from that card; typically casinos only verify the identity of a player when a TITO voucher is presented to be exchanged for cash.

To use a TITO card, a user—or, more generally, any individual in possession of the card—may fund an account associated with the TITO card by presenting cash to the casino or by debiting one or more real money accounts, such as a checking or savings account with a financial institution, or charging one or more credit card or similar accounts. These debits and credits may be exchanged for casino “points” redeemable at the casino and other physical and digital properties.

Points in a player account may be redeemed for practically any purpose in a casino environment, including wagering, bets using a casino game, purchasing meals or other goods, attending shows, or other activities. Points may also be converted back into cash at the player's request. The exchange of cash for points and vice versa may occur at booths, at electronic gaming machines, betting tables, on-line, via mobile device software applications, or otherwise.

The underlying game-play of casino gaming machines and systems are tightly regulated by one or more regulatory bodies that may vary from jurisdiction to jurisdiction. As noted above, any change to certain hardware and/or software components of an electronic gaming machine 103 often requires re-verification and re-approval by gaming regulators. The re-certification process can be lengthy and expensive and, during the process, an electronic gaming machine 103 is taken offline and is unavailable to players.

These regulatory and technical constraints often discourage casino operators from changing the underlying functionality or otherwise modifying casino games, including the game machine processing unit(s) that facilitate gameplay, manage betting, process transactions, and/or maintain meters in an electronic gaming machine. Instead, new functionality and hardware is typically designed in such a manner as to be isolated and/or insulated from any regulated hardware or software components, and, ideally, to not require interaction with them at all.

Additionally, as may be appreciated, electronic gaming machines 103 may be in operation for decades. It is therefore often desirable for new features and functionality to be easily retrofitted to older electronic gaming machines 103, some of which may not have been designed with modern technological capabilities in mind.

One approach for addressing some of the above-referenced regulatory challenges has involved the optional use of the peripheral network adapter (PNA) 104, commonly known as a slot machine interface board. The peripheral network adapter (PNA) 104 may enable an electronic gaming machine 103 and/or an external server or system to communicate with one or more peripheral devices without the involvement of or interaction with a game machine processing unit. These peripheral devices typically do not affect underlying game-play of an electronic gaming machine 103 (which is controlled by a game machine processing unit) but do provide additional incentives and features to players. For example, rewarding of coupons, notifying players of promotions, or otherwise are often provided by peripheral devices interconnected to one or more electronic gaming machines by one or more peripheral network adapters (PNA) 104.

The peripheral network adapter (PNA) 104 also may enable an electronic gaming machine 103 to communicate with other casino system servers and external servers over one or more networks, again without involving the game machine processing unit. In further examples, other designs are considered, some of which virtualize the function of the peripheral network adapter (PNA) 104 within an electronic gaming machine 103 processor. Depending on a particular implementation, different approaches may be required to incorporate new functionality without requiring re-certification of the game machine processing unit. Several examples of such systems are described in U.S. patent application Ser. No. 15/482,615, filed on Sep. 22, 2016, and entitled “Bill Validation and Cash Dispensing Device, System and Method for Use in a Casino Context;” U.S. patent application Ser. No. 15/482,668, filed on Apr. 7, 2017, and entitled “Device, System, and Method for Facilitating Communications Between Electronic Gaming Machines and Mobile Devices;” U.S. patent application Ser. No. 16/130,346, filed on Sep. 13, 2018, and entitled “Network Architecture for Gaming Industry Accounting;” and U.S. patent application Ser. No. 16/823,677, filed on Mar. 19, 2020, and entitled “Transactions Methods for Mobile Wallet Operations in a Gaming Environment;” the entire contents of which all are incorporated herein by reference.

The processor of the mobile device 109 may be implemented as any mobile device 109 capable of processing, receiving, or transmitting data or instructions. For example, the processor can be a microprocessor, a central processing unit, an application-specific integrated circuit, a field-programmable gate array, a digital signal processor, an analog circuit, a digital circuit, or combination of such devices. The processor may be a single-thread or multi-thread processor. The processor may be a single-core or multi-core processor.

The peripheral network adapter (PNA) 104 may be configured to communicate with, and securely transact information with, the mobile device 109 of a user via the wireless interface 105. As a result of this construction, when the peripheral network adapter (PNA) 104 receives identity or identifying information from a personal electronic device, the peripheral network adapter (PNA) 104 may coordinate the connection of the user's account to the electronic gaming machine 103 to quickly and efficiently enable game play for that user on that machine. In some cases, this process is performed transparently to the user; a user may sit at an electronic gaming machine 103 and immediately begin interacting. In other embodiments, the process is performed with user interaction; a user may sit at an electronic gaming machine 103 and receive an alert on their mobile device 109 requesting permission to associate the user's account with that electronic gaming machine 103. In each of these, and other, examples provided herein, the user may not be required to handle, secure, or maintain any player card, voucher, or other cashless token in order to interact with an electronic gaming machine 103 in a casino.

The wireless interface 105 may be configured to establish a secure or other connection with the mobile device 109 (and/or an application executing on the mobile device 109) of a user using any suitable technique.

In one embodiment, each of the electronic gaming machine 103, the peripheral network adapter (PNA) 104, and the wireless interface 105 may be provided or disposed, partially entirely, and/or otherwise associated with the gaming cabinet 102. The printer 108 and the bill validator 107 may also be provided, if desired, in the gaming cabinet 102, or separately, as desired for any given implementation of one or more of the present embodiments or an equivalent thereof.

As noted with respect to other embodiments described herein, the wireless interface 105 may be configured to utilize any mobile device interconnection components, protocols, and technologies, including, but not limited to, Bluetooth™, Wi-Fi, NFC, cellular, and other known and/or later to be discovered wireless communications protocols, devices, and systems and otherwise. In many examples, the wireless interface 105 may also include at least one wired connection that can directly and/or conductively couple to the mobile device 109 (e.g., via a cable connection, a dock, and so on).

In one embodiment, the wireless interface 105 may be configured for communicating, via one or more wireless radio frequency protocols, data signals to and from a mobile device 109 using near-field communications and Bluetooth protocols. For simplicity of description, this example is discussed in greater detail below, but it may be appreciated that this is merely one example embodiment; other systems, such as described herein, can configure a peripheral network adapter (PNA) 104 to communicate with the mobile device 109 using any other suitable technique.

Continuing the example introduced above, the mobile device 109 may be configured to identify and authenticate a user associated with the mobile device 109 to one or more servers provided in a casino system, such as the casino management server 110 and/or system, the peripheral system 101, and so on. More specifically, the mobile device 109 may include a processor and a memory in which identifying information of the player is stored. The processor of the mobile device 109 may be configured to execute a program, application, or service according to executable instructions stored in the memory. The application, when launched by the processor, can optionally provide a user with a graphical user interface to input, edit, or remove various personally-identifying details such as, but not limited to: name information; address information; tax information; photographic information; driver's license information; financial information; and so on. In other embodiments, the application executed by the processor of the mobile device 109 may be configured to access one or more details stored in a preferences file in the memory. In yet another example, the application executed by the processor of the mobile device 109 may be configured to access one or more remote databases to establish or obtain identity or identifying information of the user operating the mobile device 109. Example remote databases include, but are not limited to: cellular service subscriber databases; social media or social network databases; third-party authentication services; government or municipal licensing services; and so on. In still further examples, the application executed by the processor of the mobile device 109 may present a graphical user interface that requests a user of the mobile device 109 to manually input identifying information and/or credentials. For example, the mobile device 109 may request that a user of the mobile device 109 submit credentials to log into a third-party database, such as a social media website or a third-party authentication service or an account server provided by or otherwise associated with the casino.

It may be appreciated that the foregoing example embodiments are not exhaustive; it may be appreciated that a mobile device 109, such as described herein, may be configured to store, obtain, and/or otherwise retrieve suitable identifying information sufficient to associate a user or other operator or holder of the mobile device 109 with one or more accounts associated with the casino or a particular electronic gaming machine 103. In other embodiments, a mobile device 109 may, without limitation: request an account number to verify a user's identity; take a picture with a camera module to verify a user's identity; request or require a user solve a Turing test; request or require a user to provide biometric information (e.g., fingerprint, facial depth map, vein map, iris scan, and so on); request or require a user to repeat a phrase into a microphone; request or require a user to log into one or more third-party services or websites; request or require a user to present a code generated on the mobile device 109 to an employee of the casino, an electronic gaming machine 103, or another device; request or require a user take a photo or scan a government-issued identity document, such as a driver's license or passport; request or require a user enter a pin code or passcode every time identity information is requested by an electronic gaming machine 103 or a dedicated processing unit in an electronic gaming machine 103; request or require a user agree to a terms of use document or agreement; request or require a user verify the user's age; request or require the user take a photograph or scan of a credit or debit card; and so on or any combination, sequence, or series thereof.

Further, it may be appreciated that the mobile device 109 may communicate information about a user in any suitable manner to the wireless interface 105. For example the mobile device 109 such as described herein can communicate—either encrypted or unencrypted—without limitation: a name; a birthdate; a picture; a driver's license number; a passport number; a pin code; an account number; a cryptographic signature or public key; an account balance; a wager preference (e.g., max, min, denomination, and so on); a diet preference; a drink preference; a gameplay parameter preference (e.g., playback speed, animation preferences; bet parameters, and so on); a show or event attendance preference; a time or duration since a particular event; a citizenship; an age; an address; version information about an operating system of the personal electronic device; version information about an application operating on the personal electronic device; performance information about the user; betting history of the user; and so on or any combination, sequence, or series thereof.

In view of the foregoing, it may be appreciated that the mobile device 109, such as described herein, may be configured in any suitable manner to request or obtain information about a user in any suitable way. As such, the phrase “information” about a user as used herein is understood to refer to any information or data—whether stored in, accessed by, obtained by, provided to, or requested by the mobile device 109—relevant or otherwise related to a user or the user's mobile device 109. This information can be communicated in an encrypted or unencrypted manner, in a compressed or uncompressed manner, and according to any suitable file format or data transmission protocol now known or later discovered.

It may be understood that the mobile device 109 may be provided by a player, provided by the casino, or otherwise. As noted above, the mobile device 109 may be any device configured to wirelessly identify and/or authenticate a user to a casino management system server, such as the casino management server 110 and/or system.

The wireless interface 105 may be configured to identify and authenticate the mobile device 109 by the presence of any desired form of electronic identification or other provisioning of data. By way of illustration only and not by means of limitation, examples of such electronic identification forms may include near-field communication generated signals, Wi-Fi signals, Bluetooth™ signals, other known communications technologies, and optical images such as two-dimensional or other bar codes, QR (“quick response”) codes, and otherwise.

The foregoing embodiments depicted in FIG. 1 and the various alternatives thereof and variations thereto are presented, generally, for purposes of explanation, and to facilitate an understanding of various configurations and constructions of a network architecture that facilitates communication by and between various components of a player's personal electronic device, an electronic gaming machine, and/or one or more casino servers or systems, and the various components thereof, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

Although the above is illustrated and described in the context of mobile wallet operations in a gaming environment, it is understood that this is an example. The techniques herein may be used in other contexts without departing from the scope of the present disclosure. Other configurations are possible and contemplated.

FIG. 2 depicts a first example data flow 200 for mobile wallet operations in a gaming environment. The data flow 200 may be implemented using the system 100 of FIG. 1.

A mobile device 209 may wirelessly couple and/or otherwise associate with an electronic gaming machine as part of the performance of one or more various mobile wallet operations. Such wireless coupling and/or otherwise associating may establish communication connections for such mobile wallet operations, secure communications for such mobile wallet operations, establish the particular mobile wallet and/or other identifying and/or other account information involved in such mobile wallet operations, establish the particular electronic gaming machine involved in such mobile wallet operations, and so on.

In a first example, the mobile device 209 may use NFC or other wireless technology to identify and communicate through the wireless interface with peripheral network adapter (PNA) 204/205 associated with the electronic gaming machine. By way of a second example, the peripheral system 201 may send pairing information (such as by using NFC, one or more barcodes, and so on) to the mobile device 209 via the wireless interface with peripheral network adapter (PNA) 204/205 that may then be used to establish a connection using a different mechanism and/or wireless technology, such as Bluetooth™, Wi-Fi, cellular, and so on. In still another example, the mobile device 209 may read and/or otherwise obtain pairing information from the electronic gaming machine (such as through a barcode, numeric passcode, and so on presented via a player interface associated with the electronic gaming machine, coupled to a gaming cabinet associated with the electronic gaming machine, and so on) in order to identify and establish a wireless connection, such as Bluetooth™, Wi-Fi, cellular, and so on.

After the mobile device 209 wirelessly couples and/or otherwise associates with the electronic gaming machine, the mobile device 209 may then communicate with the peripheral system 201 as part of the performance of the one or more various mobile wallet operations. The mobile device 209 may perform such communications in a variety of ways.

For example, the mobile device may communicate with the peripheral system 201 via an indirect connection through the wireless interface with peripheral network adapter (PNA) 204/205 using a wireless technology, such as NFC, Bluetooth™, and so on. By way of another example, the mobile device may communicate with the peripheral system 201 directly using a wireless technology, such as cellular, Wi-Fi, and so on.

By way of illustration, the data flow 200 of FIG. 2 illustrates the mobile device 209 sending pairing information to the wireless interface with peripheral network adapter (PNA) 204/205. The wireless interface with peripheral network adapter (PNA) 204/205 may then send the pairing information to the peripheral system 201. In response, the peripheral system 201 may send a pairing acknowledgement to the wireless interface with peripheral network adapter (PNA) 204/205, which may send the pairing acknowledgement to the mobile device 209. Subsequently, the mobile device 209 may send a fund transfer request to the wireless interface with peripheral network adapter (PNA) 204/205, which may send the fund transfer request to the peripheral system 201. Alternatively and/or additionally, the mobile device 209 may send the fund transfer request and/or another fund transfer request to the peripheral system 201.

In some examples, the mobile device 209 and the peripheral system 201 may communicate through the wireless interface with peripheral network adapter (PNA) 204/205 as this may represent more secure communication connection whereas the mobile device 209 and the peripheral system 201 may communicate directly using cellular, Wi-Fi, or other technology when security is not as great a concern. However, in other examples, direct communication between the mobile device and the peripheral system 201 may be just as secured, if not more secured, than indirect communication using the wireless interface with peripheral network adapter (PNA) 204/205. Various configurations are possible and contemplated without departing from the scope of the present disclosure.

The fund transfer request may be any kind of fund transfer request. Such a fund transfer request may involve debiting and/or crediting any kind of mobile wallet and/or other account discussed herein. For example, the fund transfer request may involve debiting a mobile wallet and/or other account as part of a game-crediting process, such as the game-crediting processes discussed in detail below. By way of another example, the fund transfer request may involve crediting a mobile wallet and/or other account as part of a cash out operation involving the electronic gaming machine. Various configurations are possible and contemplated without departing from the scope of the present disclosure.

In various examples, this example data flow 200 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 200 is illustrated and described as including particular operations performed in a particular order, it is understood that this is an example. In various implementations, various orders of the same, similar, and/or different operations may be performed without departing from the scope of the present disclosure.

For example, the data flow 200 illustrates and describes the mobile device 209 and the peripheral system 201 indirectly communicating pairing information and pairing acknowledgements via the wireless interface with peripheral network adapter (PNA) 204/205. However, it is understood that this is an example. In some implementations, the mobile device 209 and the peripheral system 201 may communicate pairing information and pairing acknowledgements without involving the wireless interface with peripheral network adapter (PNA) 204/205. By way of illustration, the mobile device 209 may read and/or otherwise obtain pairing information from the electronic gaming machine (such as through a barcode, numeric passcode, and so on presented via a player interface associated with the electronic gaming machine, coupled to a gaming cabinet associated with the electronic gaming machine, and so on) in order to identify and establish a wireless connection, such as Bluetooth™, Wi-Fi, cellular, and so on. Various configurations are possible and contemplated without departing from the scope of the present disclosure.

By way of another example, the data flow 200 illustrates and describes the wireless interface with peripheral network adapter (PNA) 204/205. However, it is understood that this is an example. In various implementations, the wireless interface with peripheral network adapter (PNA) 204/205 may be two separate devices (such as a wireless interface and a peripheral network adapter (PNA)), a single device that integrates the functionality of a wireless interface and a peripheral network adapter (PNA), and so on. Discussion herein of a wireless interface and a peripheral network adapter (PNA) as a single device and/or multiple devices is not intended to be limiting and it is understood that a single device that integrates the functionality of a wireless interface and a peripheral network adapter (PNA) may be substituted for multiple devices and vice versa. Various configurations are possible and contemplated without departing from the scope of the present disclosure.

In still another example, the data flow 200 illustrates and describes the mobile device 209 as a smart phone. However, it is understood that this is an example. In various implementations, the mobile device may be any kind of mobile device (such as a payment card, a mobile phone, a tablet, a laptop, a smart watch, a smart card, a smart key chain, an implantable smart chip, a personal digital assistant, a digital media player, and so on). Description and/or depiction of a particular kind of mobile device is not intended to be limiting and it is understood that a particular kind of mobile device may be substituted for the one depicted and/or illustrated. Various configurations are possible and contemplated without departing from the scope of the present disclosure.

In various implementations, the fund transfer request discussed above may specify an amount of funds to transfer. This may be specified by a user (or “player”) via the mobile device 209 and/or otherwise specified. However, it is understood that this is an example and that other configurations are possible and contemplated without departing from the scope of the present disclosure.

For example, a preset amount may be used for each fund transfer. By way of illustration, each fund transfer may transfer $5, $10, $20, $50, $100, and/or another preset amount (such as from a specific pre-designated mobile wallet and/or other account discussed herein) and credit the electronic gaming machine accordingly. The preset amount may be configured in the peripheral system 201, the wireless interface with peripheral network adapter (PNA) 204/205 (such as by an operation of the electronic gaming machine), the mobile device 209 (such as by the user), and so on.

The funding process may be performed in a variety of different ways. Examples include, but are not limited to, using a card payment, using mobile payments, using a player wallet system, and so on.

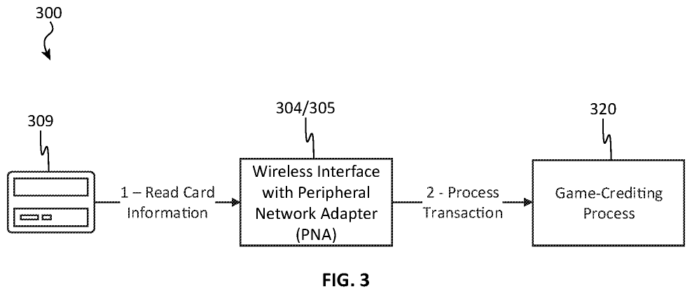

For example, FIG. 3 depicts a second example data flow 300 for mobile wallet operations in a gaming environment. The data flow 300 may be implemented using the system 100 of FIG. 1.

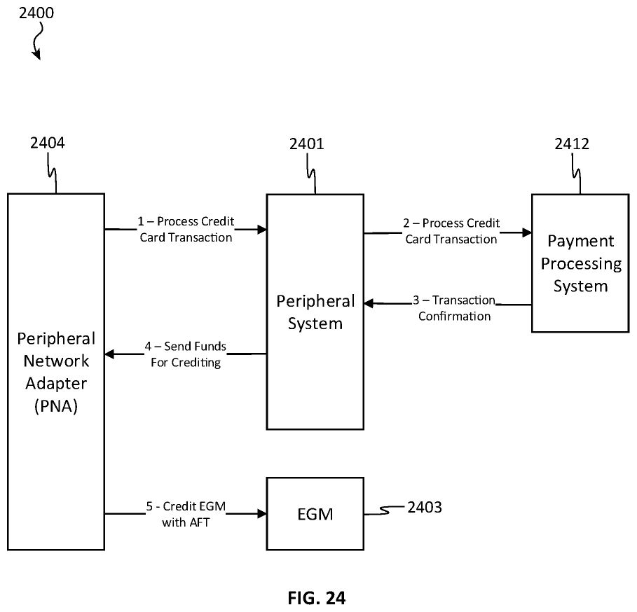

The data flow 300 illustrates using a card payment for a funding process. In this example, a user may use a wireless interface with peripheral network adapter (PNA) 304/305 associated with an electronic gaming machine to transfer a preset amount of funds using a card payment with NFC, RFID, magnetic stripe, smart chip, and so on. The peripheral network adapter (PNA) 304/305 may read card information from a mobile device 309. The card information may then be used to process one or more transactions using one or more game crediting processes 320. Examples of such game crediting processes are discussed in detail below with respect to FIGS. 24-31.

In various examples, this example data flow 300 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 300 is illustrated and described as including particular operations performed in a particular order, it is understood that this is an example. In various implementations, various orders of the same, similar, and/or different operations may be performed without departing from the scope of the present disclosure.

For example, the data flow 300 is illustrated and described as transferring a preset amount of funds. However, it is understood that this is an example. In some implementations, the wireless interface with peripheral network adapter (PNA) 304/305 associated with the electronic gaming machine may be used to transfer an amount of funds that is not preset. Various configurations are possible and contemplated without departing from the scope of the present disclosure.

In other examples, a user may use a contactless payment and/or other mobile payment service. Examples of such contactless payment and/or other mobile payment services may include, but are not limited to, Apple Pay™, Google Pay™, and so on. Such contactless payment and/or other mobile payment services may involve using a mobile device to communicate with the respective mobile payment service, receiving information associated with a payment that is ready for use, and wirelessly and/or otherwise providing that information received from the mobile payment service to complete the payment.

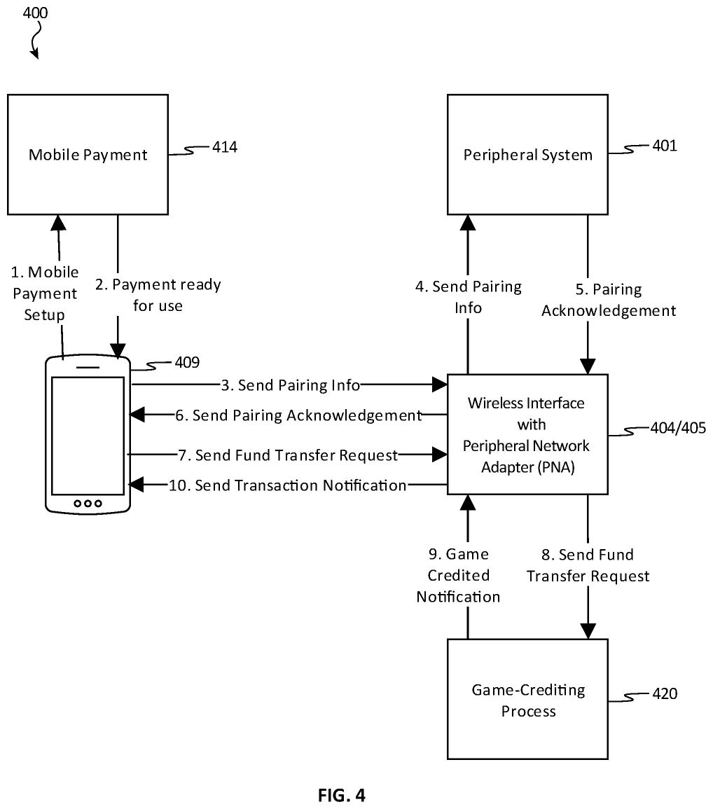

For example, FIG. 4 depicts a third example data flow 400 for mobile wallet operations in a gaming environment. The data flow 400 may be implemented using the system 100 of FIG. 1.

As shown, a user may use a mobile device 409 to set up a payment with a mobile payment 414 system. The mobile device 409 may communicate with the mobile payment 414 system and receive information that the payment is ready for use. The mobile device 409 may send pairing information to a wireless interface with a peripheral network adapter (PNA) 404/405 associated with an electronic gaming machine, and the wireless interface with peripheral network adapter (PNA) 404/405 may send the pairing information to a peripheral system 401 and receive a pairing acknowledgment in return. The wireless interface with a peripheral network adapter (PNA) 404/405 and/or the peripheral system 401 may store data regarding the pairing in order to associate fund transfers with the appropriate electronic gaming machine and user and/or fund transfer request and/or other associated information. The wireless interface with a peripheral network adapter (PNA) 404/405 may send the pairing acknowledgement to the mobile device 409.

The mobile device 409 may then use the information received from the mobile payment 414 system to send a fund transfer request to the wireless interface with a peripheral network adapter (PNA) 404/405. The fund transfer request may be for a preset amount. The wireless interface with a peripheral network adapter (PNA) 404/405 may send the fund transfer request to a game-crediting process 420 and receive a game credited notification in return that indicates that the fund transfer was used to credit the electronic gaming machine. The wireless interface with a peripheral network adapter (PNA) 404/405 may then send a transaction notification to the mobile device 409.

In various examples, this example data flow 400 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 400 is illustrated and described as including particular operations performed in a particular order, it is understood that this is an example. In various implementations, various orders of the same, similar, and/or different operations may be performed without departing from the scope of the present disclosure.

For example, the data flow 400 is illustrated and described as the mobile device 409 communicating with the peripheral system 401 via the wireless interface with a peripheral network adapter (PNA) 404/405. However, it is understood that this is an example. In some implementations, the mobile device 409 may communicate with the peripheral system 401 directly without involving the wireless interface with a peripheral network adapter (PNA) 404/405. Various configurations are possible and contemplated without departing from the scope of the present disclosure.

In other examples, a user may use a mobile device to select funds from a player wallet system and tap, bump, and/or otherwise wirelessly couple the mobile device to a wireless interface associated with an electronic gaming machine to transfer a preset and/or other amount of funds. The player wallet system may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. In such examples, the mobile device may use Wi-Fi, cellular, Bluetooth™, and/or other network and/or communication technology to contact the player wallet system and retrieve the user's account information. This may include available funds. The user may then select the funds from which the preset and/or other amount will be deducted.

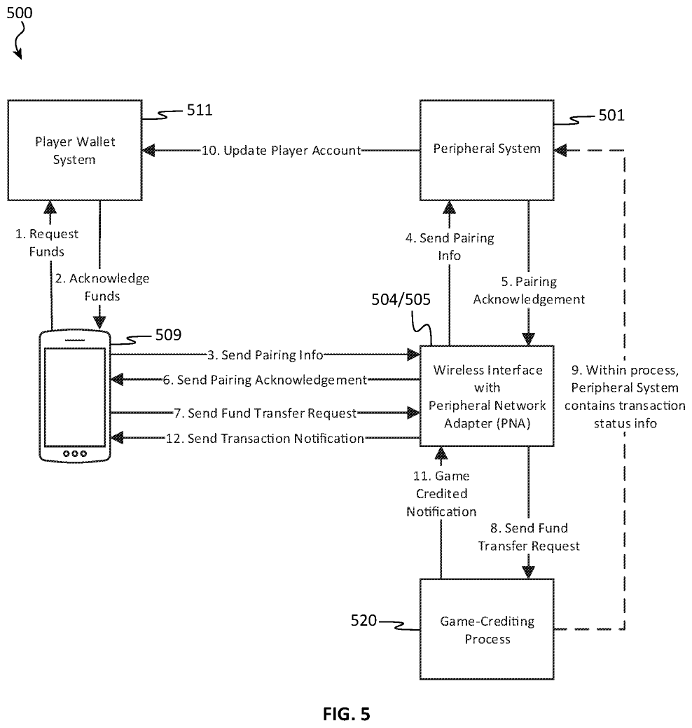

By way of example, FIG. 5 depicts a fourth example data flow 500 for mobile wallet operations in a gaming environment. The data flow 500 may be implemented using the system 100 of FIG. 1.

A user may use a mobile device 509 to request funds from a player wallet system 511. The request for funds may be for a preset amount. The player wallet system 511 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The mobile device 509 may receive an acknowledgement of funds from the player wallet system 511. The mobile device 509 may send pairing information to a wireless interface with a peripheral network adapter (PNA) 504/505 associated with an electronic gaming machine, and the wireless interface with peripheral network adapter (PNA) 504/505 may send the pairing information to a peripheral system 501 and receive a pairing acknowledgment in return. The wireless interface with a peripheral network adapter (PNA) 504/505 may send the pairing acknowledgement to the mobile device 509. The wireless interface with a peripheral network adapter (PNA) 504/505 and/or the peripheral system 501 may store data regarding the pairing in order to associate fund transfers with the appropriate electronic gaming machine and user and/or fund transfer request and/or other associated information. The mobile device 509 may then send a fund transfer request associated with the player wallet system 511 to the wireless interface with a peripheral network adapter (PNA) 504/505. The wireless interface with a peripheral network adapter (PNA) 504/505 may send the fund transfer request to a game-crediting process 520. The game-crediting process 520 may involve storing transaction status information in the peripheral system 501, which may update the player wallet system 511 accordingly based on the funds transfer, and providing a game credited notification indicating that the fund transfer was used to credit the electronic gaming machine to the wireless interface with a peripheral network adapter (PNA) 504/505. The wireless interface with a peripheral network adapter (PNA) 504/505 may then send a transaction notification to the mobile device 509.

In various examples, this example data flow 500 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 500 is illustrated and described as including particular operations performed in a particular order, it is understood that this is an example. In various implementations, various orders of the same, similar, and/or different operations may be performed without departing from the scope of the present disclosure.

For example, in some implementations, a player interface (such as a touch screen and/or other user interface device) associated with the electronic gaming machine may be used to interact with the player wallet system 511 instead of the mobile device 509. In such an implementation, the mobile device 509 may be omitted. Various configurations are possible and contemplated without departing from the scope of the present disclosure.

In other implementations, a peripheral network adapter (PNA) may communicate with a player wallet system instead of a mobile device communicating with the player wallet system. For example, a user may use a mobile device to interface with a peripheral network adapter (PNA) via wireless communication (such as NFC, Bluetooth™, Wi-Fi, and so on). The peripheral network adapter (PNA) may contact a player wallet system and retrieve the user's account information. This account information may include information regarding available funds. The peripheral network adapter (PNA) may then send the information regarding the available funds to the mobile device via a wireless interface. The user may then use the mobile device to select which funds to redeem.

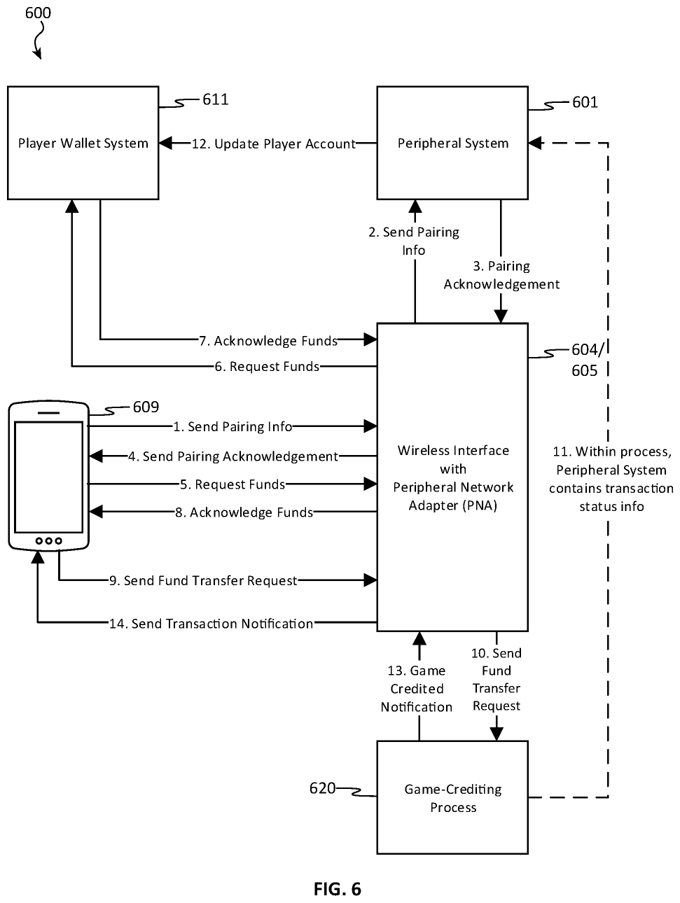

By way of illustration, FIG. 6 depicts a fifth example data flow 600 for mobile wallet operations in a gaming environment. The data flow 600 may be implemented using the system 100 of FIG. 1.

A user may use a mobile device 609 to send pairing information to a wireless interface with a peripheral network adapter (PNA) 604/605 associated with an electronic gaming machine. The wireless interface with peripheral network adapter (PNA) 604/605 may send the pairing information to a peripheral system 601 and receive a pairing acknowledgment in return, which the peripheral network adapter (PNA) 604/605 may provide to the mobile device 609. The wireless interface with a peripheral network adapter (PNA) 604/605 and/or the peripheral system 601 may store data regarding the pairing in order associate fund transfers with the appropriate electronic gaming machine and user and/or fund transfer request and/or other associated information.

The user may then use the mobile device 609 to send a request for funds to the wireless interface with a peripheral network adapter (PNA) 604/605. The request for funds may be for a preset amount. The wireless interface with a peripheral network adapter (PNA) 604/605 may send the request for funds to a player wallet system 611 and receive a response that acknowledges the funds. The player wallet system 611 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The wireless interface with a peripheral network adapter (PNA) 604/605 may then send a fund transfer request based on the acknowledgement to a game-crediting process 620. The game-crediting process 620 may involve storing transaction status information in the peripheral system 601, which may update the player wallet system 611 accordingly based on the fund transfer, and providing a game credited notification indicating that the fund transfer was used to credit the electronic gaming machine to the wireless interface with a peripheral network adapter (PNA) 604/605. The wireless interface with a peripheral network adapter (PNA) 604/605 may then send a transaction notification to the mobile device 609.

In various examples, this example data flow 600 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 600 is illustrated and described as including particular operations performed in a particular order, it is understood that this is an example. In various implementations, various orders of the same, similar, and/or different operations may be performed without departing from the scope of the present disclosure.

For example, the game-crediting process 620 is illustrated and described in the data flow 600 as separate from the peripheral system 601 and the wireless interface with a peripheral network adapter (PNA) 604/605. However, it is understood that this is an example. In some implementations, the game-crediting process 620 may be partially and/or entirely performed by the peripheral system 601 and/or the wireless interface with a peripheral network adapter (PNA) 604/605. Various configurations are possible and contemplated without departing from the scope of the present disclosure.

Further, the data flow 600 is illustrated and described as the wireless interface with a peripheral network adapter (PNA) 604/605 communicating with the player wallet system 611 to retrieve funds. However, it is understood that this is an example. In some implementations, a peripheral system may communicate with a player wallet system to retrieve funds. Various configurations are possible and contemplated without departing from the scope of the present disclosure.

For example, a user may use a mobile device to communicate with a peripheral network adapter (PNA) via wireless communication (such as NFC, Bluetooth™, Wi-Fi, and so on). The peripheral network adapter (PNA) may communicate with a peripheral system, which may contact a player wallet system and retrieve the user's account information. This account information may include information regarding available funds. The peripheral system may then send the received information to the peripheral network adapter (PNA), which may send the information regarding the available funds to the mobile device via a wireless interface. The user may then use the mobile device to select which funds to redeem.

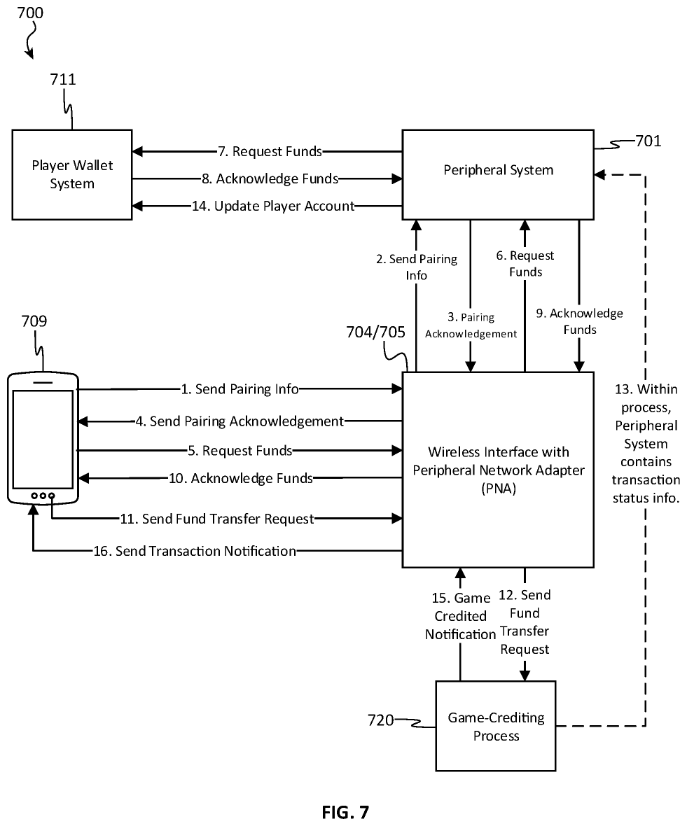

FIG. 7 depicts a sixth example data flow 700 for mobile wallet operations in a gaming environment. The data flow 700 may be implemented using the system 100 of FIG. 1.

A user may use a mobile device 709 to send pairing information to a wireless interface with a peripheral network adapter (PNA) 704/705 associated with an electronic gaming machine. The wireless interface with peripheral network adapter (PNA) 704/705 may send the pairing information to a peripheral system 701 and receive a pairing acknowledgment in return, which the peripheral network adapter (PNA) 704/705 may provide to the mobile device 709. The wireless interface with a peripheral network adapter (PNA) 704/705 and/or the peripheral system 701 may store data regarding the pairing in order to associate fund transfers with the appropriate electronic gaming machine and user and/or fund transfer request and/or other associated information.

The user may then use the mobile device 709 to send a request for funds to the wireless interface with a peripheral network adapter (PNA) 704/705. The request for funds may be for a preset amount. The wireless interface with a peripheral network adapter (PNA) 704/705 may send the request for funds to the peripheral system 701, which may send the request for funds to a player wallet system 711 and receive a response that acknowledges the funds. The player wallet system 711 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The peripheral system 701 may provide the response to the wireless interface with a peripheral network adapter (PNA) 704/705, which may then send a fund transfer request based on the acknowledgement to a game-crediting process 720.

The game-crediting process 720 may involve storing transaction status information in the peripheral system 701, which may update the player wallet system 711 accordingly based on the fund transfer, and providing a game credited notification indicating that the fund transfer was used to credit the electronic gaming machine to the wireless interface with a peripheral network adapter (PNA) 704/705. The wireless interface with a peripheral network adapter (PNA) 704/705 may then send a transaction notification to the mobile device 709.

In various examples, this example data flow 700 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 700 is illustrated and described as including particular operations performed in a particular order, it is understood that this is an example. In various implementations, various orders of the same, similar, and/or different operations may be performed without departing from the scope of the present disclosure.

For example, the data flow 700 is illustrated and described as having the wireless interface with a peripheral network adapter (PNA) 704/705 send a transaction notification to the mobile device 709. However, it is understood that this is an example. In some implementations, the wireless interface with a peripheral network adapter (PNA) 704/705 may omit sending a transaction notification to the mobile device 709. The user may instead be notified of the transaction when the electronic gaming machine presents a credit corresponding to the transaction. Various configurations are possible and contemplated without departing from the scope of the present disclosure.

FIGS. 3-7 above are illustrated and described in the context of transferring a preset amount. This may have the advantage of not having to support determining an amount that a user is transferring. However, it may also be less flexible when the user wants to transfer an amount different than the preset amount. In other examples, a user may be able to select the transfer amount. In some implementations of such examples, the user may be able to use a mobile device to select the transfer amount.

In some examples, the user may be able to use a mobile device to select the transfer amount for a transaction involving information from a payment card provided to a peripheral network adapter (PNA) associated with an electronic gaming machine via a wireless interface and/or other mechanism. In other examples, the user may be able to use a mobile device to select the transfer amount for a transaction involving information from a payment card provided to the mobile device. In still other examples, the user may be able to use a mobile device to select the transfer amount for a transaction involving a mobile payment system payment made using the mobile device. In yet other examples, the user may be able to use a mobile device to select the transfer amount for a transaction involving a player wallet system.

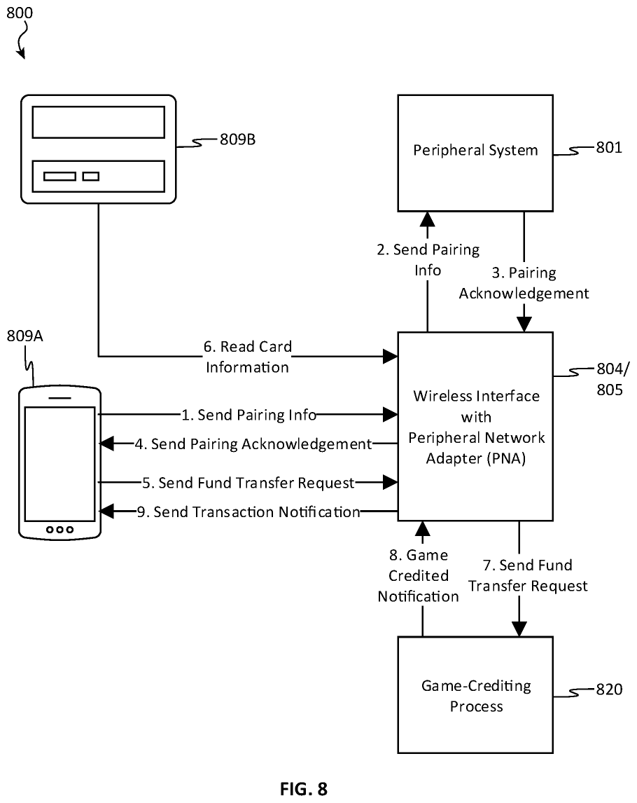

By way of illustration, FIG. 8 depicts a seventh example data flow 800 for mobile wallet operations in a gaming environment. The data flow 800 may be implemented using the system 100 of FIG. 1.

A user may use a mobile device 809A to send pairing information to a wireless interface with a peripheral network adapter (PNA) 804/805 associated with an electronic gaming machine. The wireless interface with peripheral network adapter (PNA) 804/805 may send the pairing information to a peripheral system 801 and receive a pairing acknowledgment in return, which the peripheral network adapter (PNA) 804/805 may provide to the mobile device 809A. The wireless interface with a peripheral network adapter (PNA) 804/805 and/or the peripheral system 801 may store data regarding the pairing in order associate fund transfers with the appropriate electronic gaming machine and user and/or fund transfer request and/or other associated information. The user may then use the mobile device 809A to send a request for funds to the wireless interface with a peripheral network adapter (PNA) 804/805. The request for funds may include a transfer amount specified by the user using the mobile device 809A. The wireless interface with a peripheral network adapter (PNA) 804/805 may read and/or otherwise obtain card information from a payment card and/or other mobile device 809B (such as via NFC, RFID, a magnetic stripe, a smart chip, and so on). The wireless interface with a peripheral network adapter (PNA) 804/805 may send the request for funds and the card information to a game-crediting process 820. The game-crediting process 820 may then provide a game credited notification indicating that the fund transfer was used to credit the electronic gaming machine to the wireless interface with a peripheral network adapter (PNA) 804/805. The wireless interface with a peripheral network adapter (PNA) 804/805 may then send a transaction notification to the mobile device 809A.

In various examples, this example data flow 800 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 800 is illustrated and described as including particular operations performed in a particular order, it is understood that this is an example. In various implementations, various orders of the same, similar, and/or different operations may be performed without departing from the scope of the present disclosure.

For example, the data flow 800 involves a user using the mobile device 809A to select a transfer amount for a transaction involving information from a payment card or other mobile device 809B provided to the wireless interface with a peripheral network adapter (PNA) 804/805. However, it is understood that this is an example. In other implementations, a user may be able to use a mobile device to select the transfer amount for a transaction involving information from a payment card provided to the mobile device.

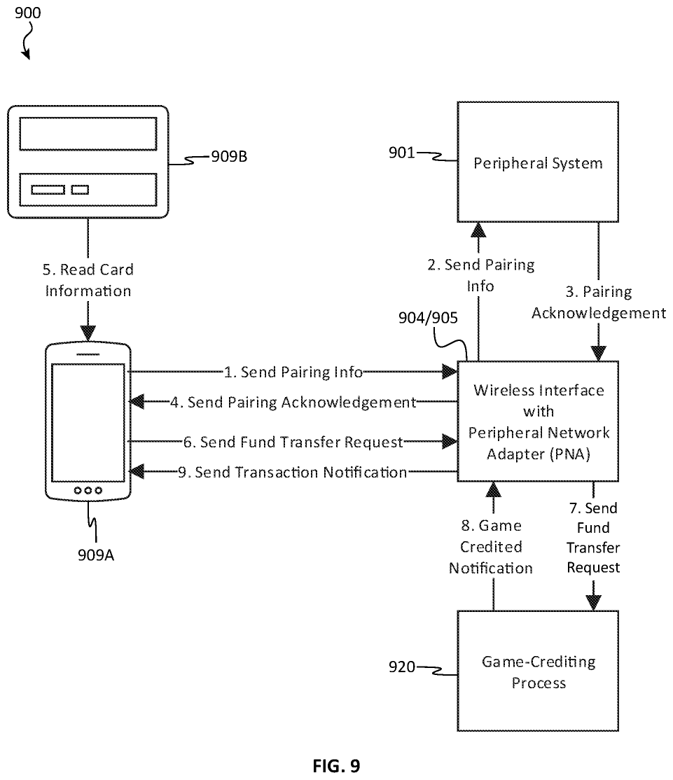

By way of illustration, FIG. 9 depicts an eighth example data flow 900 for mobile wallet operations in a gaming environment. The data flow 900 may be implemented using the system 100 of FIG. 1.

A user may use a mobile device 909A to send pairing information to a wireless interface with a peripheral network adapter (PNA) 904/905 associated with an electronic gaming machine. The wireless interface with peripheral network adapter (PNA) 904/905 may send the pairing information to a peripheral system 901 and receive a pairing acknowledgment in return, which the peripheral network adapter (PNA) 904/905 may provide to the mobile device 909A. The wireless interface with a peripheral network adapter (PNA) 904/905 and/or the peripheral system 901 may store data regarding the pairing in order to associate fund transfers with the appropriate electronic gaming machine and user and/or fund transfer request and/or other associated information.

The user may then use the mobile device 909A to read and/or otherwise obtain card information from a payment card and/or other mobile device 909B (such as via NFC, RFID, a magnetic stripe, a smart chip, and so on) and send a request for funds such as via contactless transfer) to the wireless interface with a peripheral network adapter (PNA) 904/905. The request for funds may include a transfer amount specified by the user using the mobile device 909A.

The wireless interface with a peripheral network adapter (PNA) 904/905 may send the request for funds and the card information to a game-crediting process 920. The game-crediting process 920 may then provide a game credited notification indicating that the fund transfer was used to credit the electronic gaming machine to the wireless interface with a peripheral network adapter (PNA) 904/905. The wireless interface with a peripheral network adapter (PNA) 904/905 may then send a transaction notification to the mobile device 909A.

In various examples, this example data flow 900 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 900 is illustrated and described as including particular operations performed in a particular order, it is understood that this is an example. In various implementations, various orders of the same, similar, and/or different operations may be performed without departing from the scope of the present disclosure.

For example, the data flow 900 involves a user using the mobile device 909A to select a transfer amount for a transaction involving information from a payment card or other mobile device 909B provided to the mobile device 809A. However, it is understood that this is an example. In other implementations, the user may be able to use a mobile device to select the transfer amount for a transaction involving a mobile payment system payment made using the mobile device.

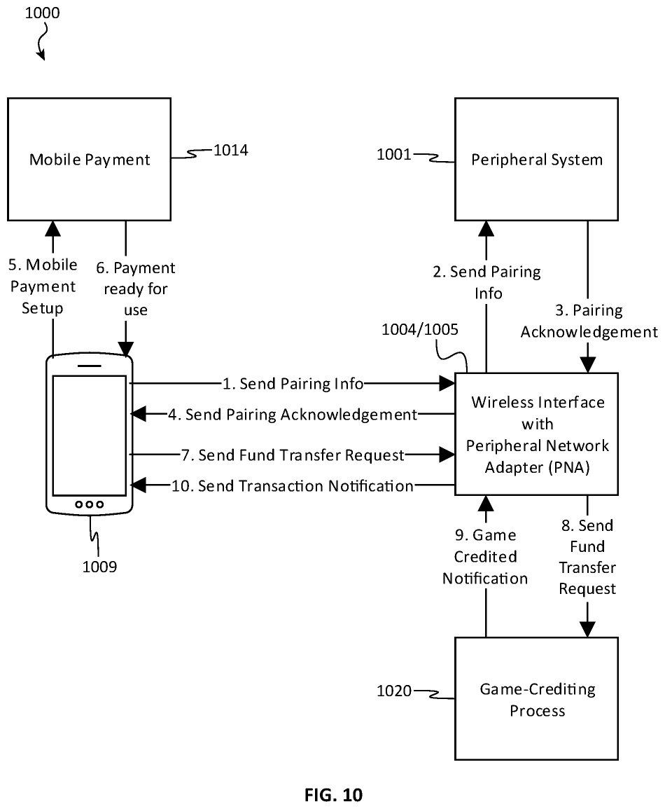

By way of illustration, FIG. 10 depicts a ninth example data flow 1000 for mobile wallet operations in a gaming environment. The data flow 1000 may be implemented using the system 100 of FIG. 1.

A user may use a mobile device 1009 to send pairing information to a wireless interface with a peripheral network adapter (PNA) 1004/1005 associated with an electronic gaming machine. The wireless interface with peripheral network adapter (PNA) 1004/1005 may send the pairing information to a peripheral system 1001 and receive a pairing acknowledgment in return, which the peripheral network adapter (PNA) 1004/1005 may provide to the mobile device 1009. The wireless interface with a peripheral network adapter (PNA) 1004/1005 and/or the peripheral system 1001 may store data regarding the pairing in order to associate fund transfers with the appropriate electronic gaming machine and user and/or fund transfer request and/or other associated information.

The user may then use the mobile device 1009 to set up a payment with a mobile payment 1014 system. Examples of such contactless payment and/or other mobile payment services may include, but are not limited to, Apple Pay™, Google Pay™, and so on. The mobile device 1009 may communicate with the mobile payment 1014 system and receive information that the payment is ready for use. The mobile device 1009 may then use the information received from the mobile payment 1014 system to send a fund transfer request to the wireless interface with a peripheral network adapter (PNA) 1004/1005. The fund transfer request may include a transfer amount specified by the user using the mobile device 909A.

The wireless interface with a peripheral network adapter (PNA) 1004/1005 may send the fund transfer request and the information from the mobile payment 1014 system to a game-crediting process 1020. The game-crediting process 1020 may then provide a game credited notification indicating that the fund transfer was used to credit the electronic gaming machine to the wireless interface with a peripheral network adapter (PNA) 1004/1005. The wireless interface with a peripheral network adapter (PNA) 1004/1005 may then send a transaction notification to the mobile device 1009.

In various examples, this example data flow 1000 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1000 is illustrated and described as including particular operations performed in a particular order, it is understood that this is an example. In various implementations, various orders of the same, similar, and/or different operations may be performed without departing from the scope of the present disclosure.

For example, the data flow 1000 involves a user using the mobile device 1009 to select a transfer amount for a transaction involving a mobile payment 1014 system payment made using the mobile device 1009. However, it is understood that this is an example. In other implementations, the user may be able to use a mobile device to select the transfer amount for a transaction involving a player wallet system.

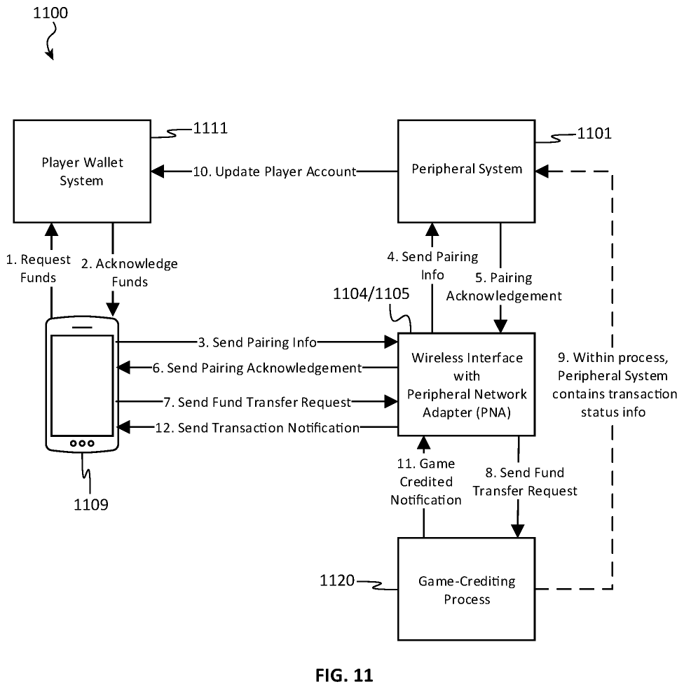

By way of illustration, FIG. 11 depicts a tenth example data flow 1100 for mobile wallet operations in a gaming environment. The data flow 1100 may be implemented using the system 100 of FIG. 1.

A user may use a mobile device 1109 to request funds from a player wallet system 1111. The player wallet system 1111 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The request for funds may include a transfer amount specified by the user using the mobile device 1109. The mobile device 1109 may receive an acknowledgement of funds from the player wallet system 1111. The acknowledgement of funds may include information regarding available funds that the mobile device 1109 may be used to select to redeem for a funds transfer. The peripheral network adapter (PNA) may then send the information regarding the available funds to the mobile device via a wireless interface. The mobile device 1109 may send pairing information to a wireless interface with a peripheral network adapter (PNA) 1104/1105 associated with an electronic gaming machine, and the wireless interface with peripheral network adapter (PNA) 1104/1105 may send the pairing information to a peripheral system 1101 and receive a pairing acknowledgment in return. The wireless interface with a peripheral network adapter (PNA) 1104/1105 may send the pairing acknowledgement to the mobile device 1109. The wireless interface with a peripheral network adapter (PNA) 1104/1105 and/or the peripheral system 1101 may store data regarding the pairing in order to associate fund transfers with the appropriate electronic gaming machine and user and/or fund transfer request and/or other associated information. The mobile device 1109 may then send a fund transfer request associated with the player wallet system 1111 to the wireless interface with a peripheral network adapter (PNA) 1104/1105. The fund transfer request may include information regarding available funds that the mobile device 1109 was used to select to redeem for a funds transfer. The wireless interface with a peripheral network adapter (PNA) 1104/1105 may send the fund transfer request to a game-crediting process 1120. The game-crediting process 1120 may involve storing transaction status information in the peripheral system 1101, which may update the player wallet system 1111 accordingly based on the funds transfer, and providing a game credited notification indicating that the fund transfer was used to credit the electronic gaming machine to the wireless interface with a peripheral network adapter (PNA) 1104/1105. The wireless interface with a peripheral network adapter (PNA) 1104/1105 may then send a transaction notification to the mobile device 1109.

In various examples, this example data flow 1100 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1100 is illustrated and described as including particular operations performed in a particular order, it is understood that this is an example. In various implementations, various orders of the same, similar, and/or different operations may be performed without departing from the scope of the present disclosure.

For example, the data flow 1100 illustrates and describes the mobile device 1109 communicating with the player wallet system 1111. However, it is understood that this is an example. In some implementations, a peripheral network adapter (PNA) may communicate with a player wallet system instead of a mobile device communicating with the player wallet system. For example, a user may use a mobile device to interface with a peripheral network adapter (PNA) via wireless communication (such as NFC, Bluetooth™, Wi-Fi, and so on). The peripheral network adapter (PNA) may contact a player wallet system and retrieve the user's account information. This account information may include information regarding available funds. The peripheral network adapter (PNA) may then send the information regarding the available funds to the mobile device via a wireless interface. The user may then use the mobile device to select which funds to redeem.

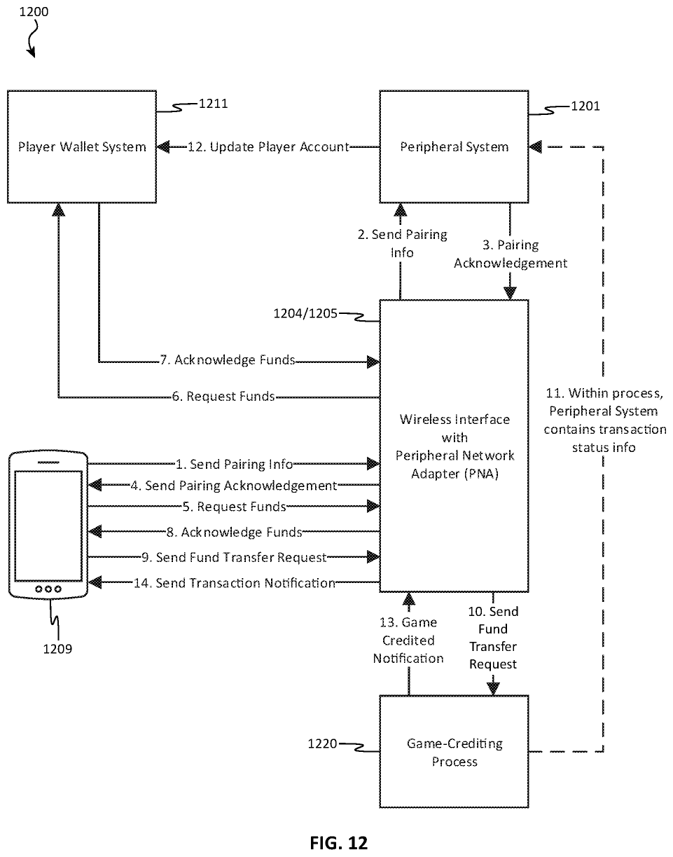

By way of illustration, FIG. 12 depicts an eleventh example data flow 1200 for mobile wallet operations in a gaming environment. The data flow 1200 may be implemented using the system 100 of FIG. 1.

A user may use a mobile device 1209 to send pairing information to a wireless interface with a peripheral network adapter (PNA) 1204/1205 associated with an electronic gaming machine, and the wireless interface with peripheral network adapter (PNA) 1204/1205 may send the pairing information to a peripheral system 1201 and receive a pairing acknowledgment in return. The wireless interface with a peripheral network adapter (PNA) 1204/1205 may send the pairing acknowledgement to the mobile device 1209. The wireless interface with a peripheral network adapter (PNA) 1204/1205 and/or the peripheral system 1201 may store data regarding the pairing in order to associate fund transfers with the appropriate electronic gaming machine and user and/or fund transfer request and/or other associated information.

The mobile device 1209 may then send a request for funds related to a player wallet system 1211 to the wireless interface with a peripheral network adapter (PNA) 1204/1205. The player wallet system 1211 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The request for funds may include a transfer amount specified by the user using the mobile device 1209. The wireless interface with a peripheral network adapter (PNA) 1204/1205 may then request the funds from the player wallet system 1211, receive an acknowledgement of the funds from the player wallet system 1211, and send the acknowledgement of the funds to the mobile device 1209. The acknowledgement of funds may include information regarding available funds that the mobile device 1209 may use to select to redeem for a funds transfer.

The mobile device 1209 may then send a fund transfer request associated with the player wallet system 1211 to the wireless interface with a peripheral network adapter (PNA) 1204/1205. The fund transfer request may include information regarding available funds that the mobile device 1209 has used to select to redeem for a funds transfer. The wireless interface with a peripheral network adapter (PNA) 1204/1205 may send the fund transfer request to a game-crediting process 1220. The game-crediting process 1220 may involve storing transaction status information in the peripheral system 1201, which may update the player wallet system 1211 accordingly based on the funds transfer, and providing a game credited notification indicating that the fund transfer was used to credit the electronic gaming machine to the wireless interface with a peripheral network adapter (PNA) 1204/1205. The wireless interface with a peripheral network adapter (PNA) 1204/1205 may then send a transaction notification to the mobile device 1209.

In various examples, this example data flow 1200 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1200 is illustrated and described as including particular operations performed in a particular order, it is understood that this is an example. In various implementations, various orders of the same, similar, and/or different operations may be performed without departing from the scope of the present disclosure.

For example, the data flow 1200 illustrates and describes the wireless interface with a peripheral network adapter (PNA) 1204/1205 communicating with the player wallet system 1211. However, it is understood that this is an example. In some implementations, a peripheral system may communicate with a player wallet system instead of a wireless interface with a peripheral network adapter (PNA) and/or a peripheral network adapter (PNA) communicating with the player wallet system. For example, a user may use a mobile device to interface with a peripheral network adapter (PNA) via wireless communication (such as NFC, Bluetooth™, Wi-Fi, and so on). The peripheral network adapter (PNA) may communicate with a peripheral system, which may contact a player wallet system and retrieve the user's account information. This account information may include information regarding available funds. The peripheral network system may then send the information regarding the available funds to the mobile device via the peripheral network adapter (PNA), which may communicate with the mobile device via a wireless interface. The user may then use the mobile device to select which funds to redeem.

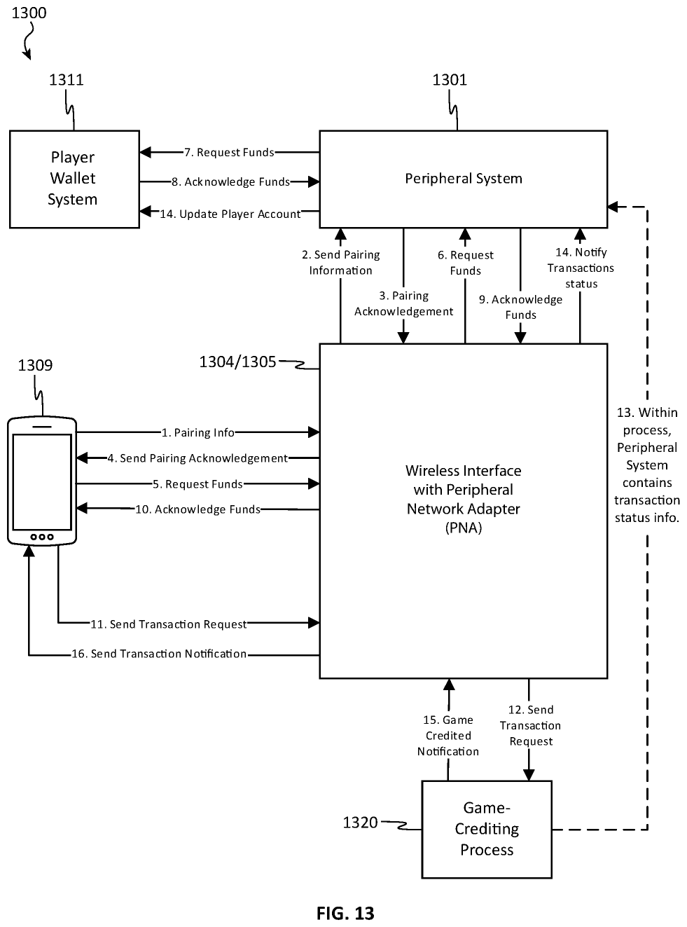

By way of illustration, FIG. 13 depicts a twelfth example data flow 1300 for mobile wallet operations in a gaming environment. The data flow 1300 may be implemented using the system 100 of FIG. 1.

A user may use a mobile device 1309 to send pairing information to a wireless interface with a peripheral network adapter (PNA) 1304/1305 associated with an electronic gaming machine, and the wireless interface with peripheral network adapter (PNA) 1204/1205 may send the pairing information to a peripheral system 1301 and receive a pairing acknowledgment in return. The wireless interface with a peripheral network adapter (PNA) 1304/1305 may send the pairing acknowledgement to the mobile device 1309. The wireless interface with a peripheral network adapter (PNA) 1304/1305 and/or the peripheral system 1301 may store data regarding the pairing in order to associate fund transfers with the appropriate electronic gaming machine and user and/or fund transfer request and/or other associated information.

The mobile device 1309 may then send a request for funds related to a player wallet system 1311 to the wireless interface with a peripheral network adapter (PNA) 1304/1305. The player wallet system 1311 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The request for funds may include a transfer amount specified by the user using the mobile device 1309. The wireless interface with a peripheral network adapter (PNA) 1304/1305 may then send the request the funds from the player wallet system 1311 to the peripheral system 1301. The peripheral system 1301 may send the request for funds from the player wallet system 1311 to the player wallet system 1311, receive an acknowledgement of the funds from the player wallet system 1311, and send the acknowledgement of the funds to the wireless interface with a peripheral network adapter (PNA) 1304/1205. The wireless interface with a peripheral network adapter (PNA) 1304/1305 may in turn send the acknowledgement of the funds to the mobile device 1309. The acknowledgement of funds may include information regarding available funds that the mobile device 1309 may use to select to redeem for a funds transfer.

The mobile device 1309 may then send a transaction request associated with the player wallet system 1311 to the wireless interface with a peripheral network adapter (PNA) 1304/1305. The transaction request may include information regarding available funds that the mobile device 1309 has used to select to redeem for a funds transfer. The wireless interface with a peripheral network adapter (PNA) 1304/1305 may send the transaction request to a game-crediting process 1320. The game-crediting process 1320 may involve storing transaction status information in the peripheral system 1301, which may update the player wallet system 1311 accordingly based on the funds transfer. The wireless interface with a peripheral network adapter (PNA) 1304/1305 may also send the peripheral system 1301 a notification of the transaction status and the game-crediting process 1320 may also involve providing a game credited notification indicating that the fund transfer was used to credit the electronic gaming machine to the wireless interface with a peripheral network adapter (PNA) 1304/1305. The wireless interface with a peripheral network adapter (PNA) 1304/1305 may then send a transaction notification to the mobile device 1309.

In various examples, this example data flow 1300 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1300 is illustrated and described as including particular operations performed in a particular order, it is understood that this is an example. In various implementations, various orders of the same, similar, and/or different operations may be performed without departing from the scope of the present disclosure.

For example, the data flow 1300 is illustrated and described as having both the wireless interface with a peripheral network adapter (PNA) 1304/1305 and the game-crediting process 1320 informing the peripheral system 1301 of the transaction status. However, it is understood that this is an example. In some implementations, one or more of these operations may be omitted. Various configurations are possible and contemplated without departing from the scope of the present disclosure.

FIGS. 8-13 above are illustrated and described in the context of a user using a mobile device to select a transfer amount. However, it is understood that this is an example. In some implementations, a user may be able to select the transfer amount using a player interface device associated with an electronic gaming machine. As the player interface device is associated with the electronic gaming machine, pairing processes may not be needed in some examples to determine the electronic gaming machine associated with a funding request.

In some examples, the user may be able to use a player interface device (such as a touch screen, keypad, tablet, service window, button, and so on) associated with an electronic gaming machine to select the transfer amount for a transaction involving information from a payment card provided to a peripheral network adapter (PNA) associated with an electronic gaming machine via a wireless interface and/or other mechanism. In other examples, the user may be able to use a player interface device (such as a touch screen, keypad, tablet, service window, button, and so on) associated with an electronic gaming machine to select the transfer amount for a transaction involving a mobile payment system payment made using the mobile device. In yet other examples, the user may be able to use a player interface device (such as a touch screen, keypad, tablet, service window, button, and so on) associated with an electronic gaming machine to select the transfer amount for a transaction involving a player wallet system.

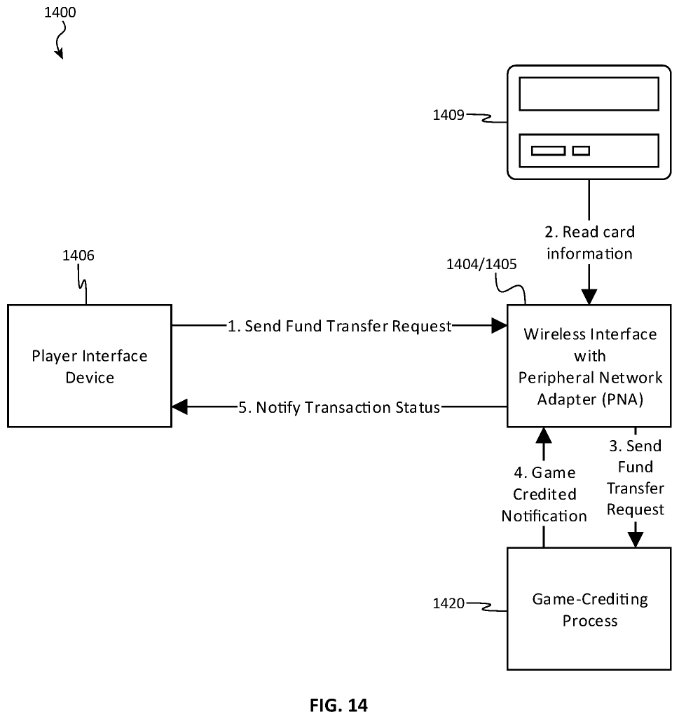

By way of illustration, FIG. 14 depicts a thirteenth example data flow 1400 for mobile wallet operations in a gaming environment. The data flow 1400 may be implemented using the system 100 of FIG. 1.

A user may use a player interface device 1406 (such as a touch screen, keypad, tablet, service window, button, and so on) associated with an electronic gaming machine to send a fund transfer request to a wireless interface with a peripheral network adapter (PNA) 1404/1405. The fund transfer request may include a transfer amount specified by the user using the player interface device 1406. The wireless interface with a peripheral network adapter (PNA) 1404/1405 may read and/or otherwise obtain card information from a payment card and/or other mobile device 1409 (such as via NFC, RFID, a magnetic stripe, a smart chip, and so on). The wireless interface with a peripheral network adapter (PNA) 1404/1405 may send the fund transfer request and the card information to a game-crediting process 1420. The game-crediting process 1420 may then provide a game credited notification indicating that the fund transfer was used to credit the electronic gaming machine to the wireless interface with a peripheral network adapter (PNA) 1404/1405. The wireless interface with a peripheral network adapter (PNA) 1404/1405 may then notify the player interface device 1406 of the transaction status.

In various examples, this example data flow 1400 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1400 is illustrated and described as including particular operations performed in a particular order, it is understood that this is an example. In various implementations, various orders of the same, similar, and/or different operations may be performed without departing from the scope of the present disclosure.

For example, the data flow 1400 is illustrated and described as having the player interface device 1406 communicate with the wireless interface with a peripheral network adapter (PNA) 1404/1405. However, it is understood that this is an example. In some implementations, a player interface device (such as a touch screen, keypad, tablet, service window, button, and so on) associated with an electronic gaming machine may communicate with a peripheral system instead of a peripheral network adapter (PNA). Various configurations are possible and contemplated without departing from the scope of the present disclosure.

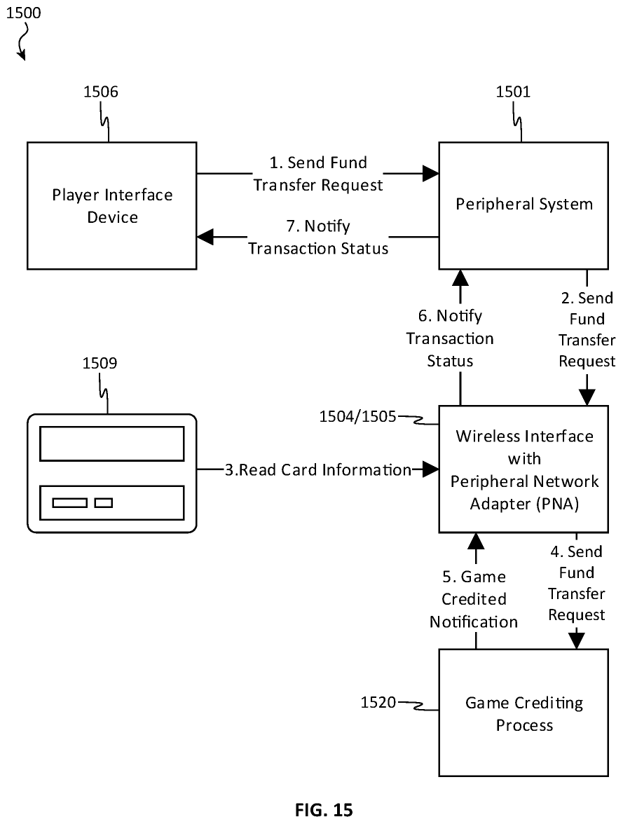

By way of illustration, FIG. 15 depicts a fourteenth example data flow 1500 for mobile wallet operations in a gaming environment. The data flow 1500 may be implemented using the system 100 of FIG. 1.

A user may use a player interface device 1506 (such as a touch screen, keypad, tablet, service window, button, and so on) associated with an electronic gaming machine to send a fund transfer request to a peripheral system 1501. The fund transfer request may include a transfer amount specified by the user using the player interface device 1506. The peripheral system 1501 may send the fund transfer request to a wireless interface with a peripheral network adapter (PNA) 1504/1505. The wireless interface with a peripheral network adapter (PNA) 1504/1505 may read and/or otherwise obtain card information from a payment card and/or other mobile device 1509 (such as via NFC, RFID, a magnetic stripe, a smart chip, and so on). The wireless interface with a peripheral network adapter (PNA) 1504/1505 may send the fund transfer request and the card information to a game-crediting process 1520. The game-crediting process 1520 may then provide a game credited notification indicating that the fund transfer was used to credit the electronic gaming machine to the wireless interface with a peripheral network adapter (PNA) 1504/1505. The wireless interface with a peripheral network adapter (PNA) 1504/1505 may then notify the peripheral system 1501 of the transaction status, which may in turn notify the player interface device 1506 of the transaction status.

In various examples, this example data flow 1500 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1500 is illustrated and described as including particular operations performed in a particular order, it is understood that this is an example. In various implementations, various orders of the same, similar, and/or different operations may be performed without departing from the scope of the present disclosure.

For example, the data flow 1500 illustrates and describes the wireless interface with a peripheral network adapter (PNA) 1504/1505 as reading and/or otherwise obtaining card information from a payment card and/or other mobile device 1509 (such as via NFC, RFID, a magnetic stripe, a smart chip, and so on). However, it is understood that this is an example. In some implementations, a player interface device, mobile device, or peripheral system may instead read and/or otherwise obtain card information from a payment card and/or other mobile device (such as via NFC, RFID, a magnetic stripe, a smart chip, and so on). Various configurations are possible and contemplated without departing from the scope of the present disclosure.

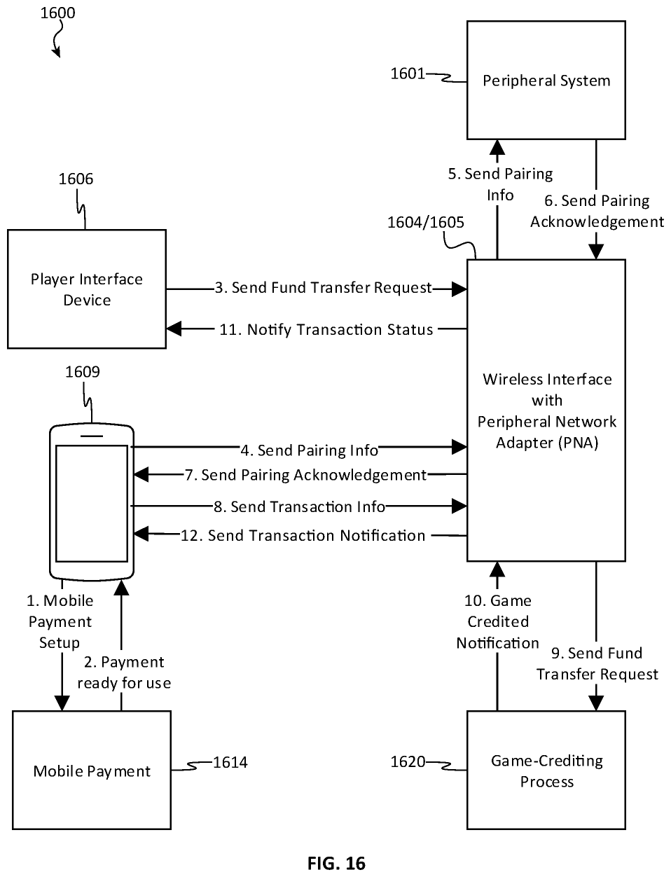

In other examples, a user may use a contactless payment service, such as Apple Pay™ Google Pay™, and so on, to perform a transfer using a wireless interface associated with an electronic gaming machine. By way of illustration, FIG. 16 depicts a fifteenth example data flow 1600 for mobile wallet operations in a gaming environment. The data flow 1600 may be implemented using the system 100 of FIG. 1.

A user may use a mobile device 1609 to set up a payment with a mobile payment 1614 system. Examples of such contactless payment and/or other mobile payment services may include, but are not limited to, Apple Pay™, Google Pay™, and so on. The mobile device 1609 may communicate with the mobile payment 1614 system and receive information that the payment is ready for use.

The user may use a player interface device 1606 (such as a touch screen, keypad, tablet, service window, button, and so on) associated with an electronic gaming machine to send a fund transfer request to a wireless interface with a peripheral network adapter (PNA) 1604/1605 associated with the electronic gaming machine. The fund transfer request may include a transfer amount specified by the user using the player interface device 1606. The user may also use the mobile device 1609 to send pairing information to the wireless interface with a peripheral network adapter (PNA) 1604/1605. The wireless interface with peripheral network adapter (PNA) 1604/1605 may send the pairing information to a peripheral system 1601 and receive a pairing acknowledgment in return, which the peripheral network adapter (PNA) 1604/1605 may provide to the mobile device 1609. The wireless interface with a peripheral network adapter (PNA) 1604/1605 and/or the peripheral system 1601 may store data regarding the pairing in order to associate fund transfers with the appropriate electronic gaming machine and user and/or fund transfer request and/or other associated information.

The user may use the mobile device 1609 to send transaction information to the wireless interface with a peripheral network adapter (PNA) 1604/1605. The transaction information may include the information from the mobile payment 1614 system. The wireless interface with a peripheral network adapter (PNA) 1604/1605 may then send a fund transfer request and the information from the mobile payment 1614 system to a game-crediting process 1620. The game-crediting process 1620 may then provide a game credited notification indicating that the fund transfer was used to credit the electronic gaming machine to the wireless interface with a peripheral network adapter (PNA) 1604/1605. The wireless interface with a peripheral network adapter (PNA) 1604/1605 may then notify the player interface device 1606 of the transaction status and send a transaction notification to the mobile device 1609.

In various examples, this example data flow 1600 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1600 is illustrated and described as including particular operations performed in a particular order, it is understood that this is an example. In various implementations, various orders of the same, similar, and/or different operations may be performed without departing from the scope of the present disclosure.

For example, the data flow 1600 is illustrated and described as having the player interface device 1606 communicate with the wireless interface with a peripheral network adapter (PNA) 1604/1605. However, it is understood that this is an example. In some implementations, a player interface device (such as a touch screen, keypad, tablet, service window, button, and so on) associated with an electronic gaming machine may communicate with a peripheral system instead of a peripheral network adapter (PNA). Various configurations are possible and contemplated without departing from the scope of the present disclosure.

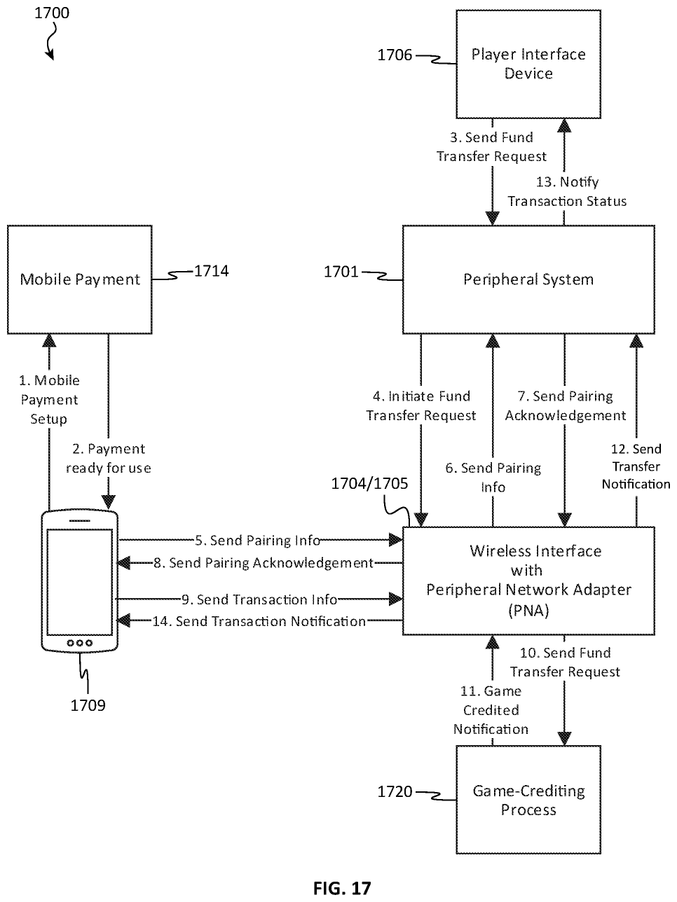

By way of illustration, FIG. 17 depicts a sixteenth example data flow 1700 for mobile wallet operations in a gaming environment. The data flow 1700 may be implemented using the system 100 of FIG. 1.

A user may use a mobile device 1709 to set up a payment with a mobile payment 1714 system. Examples of such contactless payment and/or other mobile payment services may include, but are not limited to, Apple Pay™, Google Pay™, and so on. The mobile device 1709 may communicate with the mobile payment 1714 system and receive information that the payment is ready for use.

The user may use a player interface device 1706 (such as a touch screen, keypad, tablet, service window, button, and so on) associated with an electronic gaming machine to send a fund transfer request to a peripheral system 1701. The peripheral system 1701 may then initiate a fund transfer request by communicating with a wireless interface with a peripheral network adapter (PNA) 1704/1705 associated with the electronic gaming machine. The fund transfer request may include a transfer amount specified by the user using the player interface device 1706.

The user may also use the mobile device 1709 to send pairing information to the wireless interface with a peripheral network adapter (PNA) 1704/1705. The wireless interface with peripheral network adapter (PNA) 1704/1705 may send the pairing information to the peripheral system 1701 and receive a pairing acknowledgment in return, which the peripheral network adapter (PNA) 1704/1705 may provide to the mobile device 1709. The wireless interface with a peripheral network adapter (PNA) 1704/1705 and/or the peripheral system 1701 may store data regarding the pairing in order to associate fund transfers with the appropriate electronic gaming machine and user and/or fund transfer request and/or other associated information.

The user may use the mobile device 1709 to send transaction information to the wireless interface with a peripheral network adapter (PNA) 1704/1705. The transaction information may include the information from the mobile payment 1714 system. The wireless interface with a peripheral network adapter (PNA) 1704/1705 may then send a fund transfer request and the information from the mobile payment 1714 system to a game-crediting process 1720. The game-crediting process 1720 may then provide a game credited notification indicating that the fund transfer was used to credit the electronic gaming machine to the wireless interface with a peripheral network adapter (PNA) 1704/1705. The wireless interface with a peripheral network adapter (PNA) 1704/1705 may then send transaction notifications to the peripheral system 1701, which the peripheral system 1701 may send to the player interface device 1706, and the mobile device 1609.

In various examples, this example data flow 1700 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1700 is illustrated and described as including particular operations performed in a particular order, it is understood that this is an example. In various implementations, various orders of the same, similar, and/or different operations may be performed without departing from the scope of the present disclosure.

For example, the data flow 1700 illustrates and describes the mobile device 1709 sending transaction information to the wireless interface with a peripheral network adapter (PNA) 1704/1705. However, it is understood that this is an example. In some implementations, a mobile device may send the transaction information to a peripheral system instead of a peripheral network adapter (PNA) or a wireless interface with a peripheral network adapter (PNA). Various configurations are possible and contemplated without departing from the scope of the present disclosure.

In other examples, a user may use a mobile device and/or a player interface device (such as a touch screen, keypad, tablet, service window, button, and so on) associated with an electronic gaming machine to select funds from a player wallet system. The mobile device and/or a player interface device may transfer the funds to a wireless interface device, a peripheral network adapter, and so on for redemption. The mobile device and/or the player interface device may use a network, such as Wi-Fi, cellular, Bluetooth™, and so on to contact the player wallet system, and retrieve the user's account information. This may include a list of available funds. The user may then select which funds to redeem.

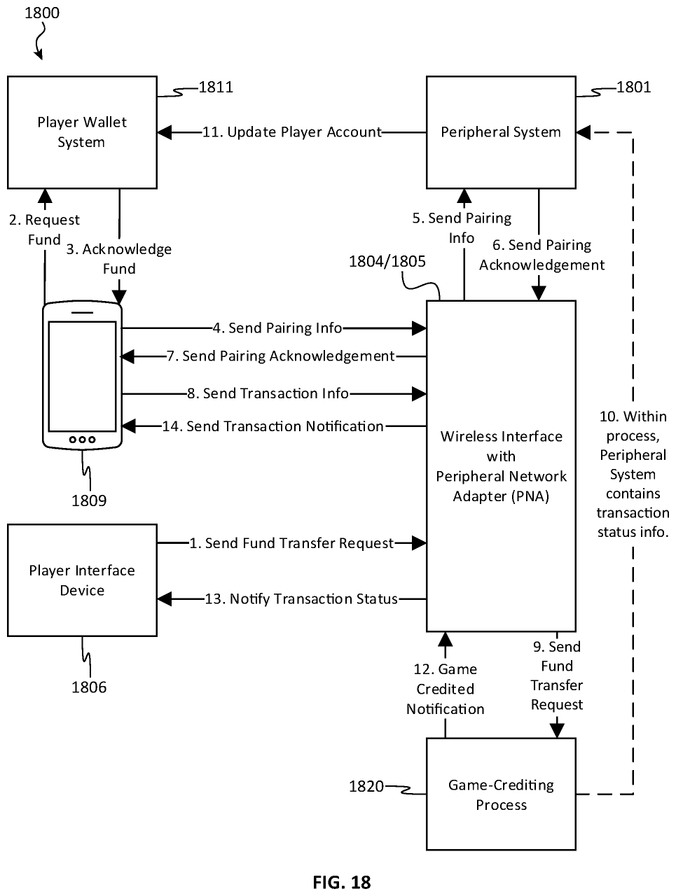

By way of illustration, FIG. 18 depicts a seventeenth example data flow 1800 for mobile wallet operations in a gaming environment. The data flow 1800 may be implemented using the system 100 of FIG. 1.

A user may use a player interface device 1806 (such as a touch screen, keypad, tablet, service window, button, and so on) associated with an electronic gaming machine to send a fund transfer request to a wireless interface with a peripheral network adapter (PNA) 1804/1805 associated with the electronic gaming machine. The fund transfer request may include a transfer amount specified by the user using the player interface device 1806. The user may also use a mobile device 1809 to request funds from a player wallet system 1811. The player wallet system 1811 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The request for funds may include a transfer amount specified by the user using the mobile device 1809. The mobile device 1809 may receive an acknowledgement of funds from the player wallet system 1811. The acknowledgement of funds may include information regarding available funds that the mobile device 1809 may use to select to redeem for a funds transfer.

The user may further use a mobile device 1809 to send pairing information to the wireless interface with a peripheral network adapter (PNA) 1804/1805, and the wireless interface with peripheral network adapter (PNA) 1804/1805 may send the pairing information to a peripheral system 1801 and receive a pairing acknowledgment in return. The wireless interface with a peripheral network adapter (PNA) 1804/1805 may send the pairing acknowledgement to the mobile device 1809. The wireless interface with a peripheral network adapter (PNA) 1804/1805 and/or the peripheral system 1801 may store data regarding the pairing in order to associate fund transfers with the appropriate electronic gaming machine and user and/or fund transfer request and/or other associated information.

The user may then use the mobile device 1809 to send transaction information to the wireless interface with a peripheral network adapter (PNA) 1804/1805. The transaction information may include information regarding available funds that the mobile device 1809 used to select to redeem for a funds transfer. The wireless interface with a peripheral network adapter (PNA) 1804/1805 may send the fund transfer request to a game-crediting process 1820. The game-crediting process 1820 may involve storing transaction status information in the peripheral system 1801, which may update the player wallet system 1811 accordingly based on the funds transfer, and providing a game credited notification indicating that the fund transfer was used to credit the electronic gaming machine to the wireless interface with a peripheral network adapter (PNA) 1804/1805. The wireless interface with a peripheral network adapter (PNA) 1804/1805 may then notify the player interface device 1806 of the transaction status and send a transaction notification to the mobile device 1809.

In various examples, this example data flow 1800 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1800 is illustrated and described as including particular operations performed in a particular order, it is understood that this is an example. In various implementations, various orders of the same, similar, and/or different operations may be performed without departing from the scope of the present disclosure.

For example, the data flow 1800 illustrates and describes the player interface device 1806 communicating with the wireless interface with a peripheral network adapter (PNA) 1804/1805. However, it is understood that this is an example. In some implementations, a player interface device (such as a touch screen, keypad, tablet, service window, button, and so on) associated with an electronic gaming machine may communicate with a peripheral system instead of a peripheral network adapter (PNA). Various configurations are possible and contemplated without departing from the scope of the present disclosure.

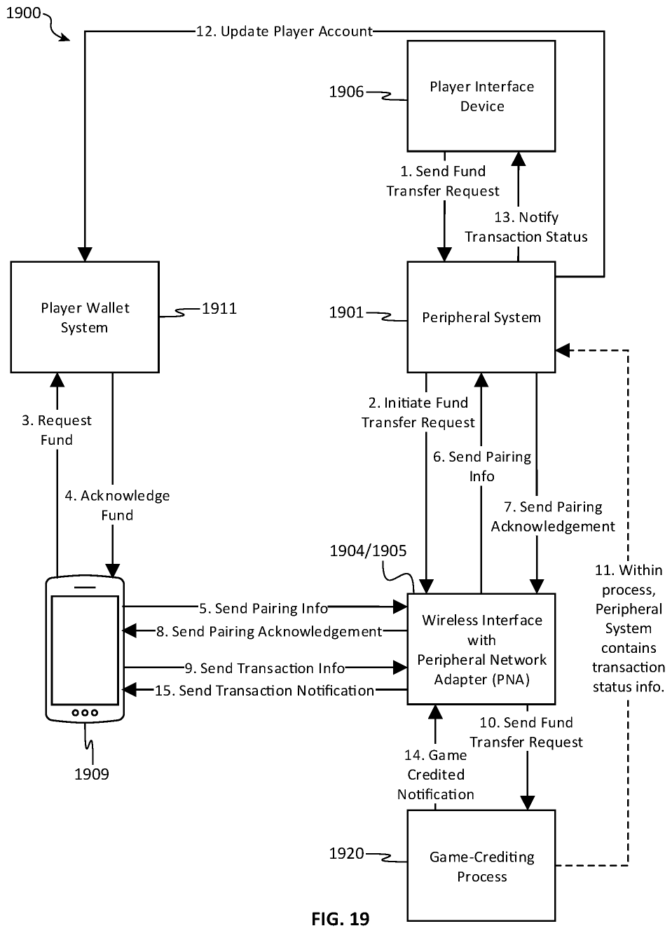

By way of illustration, FIG. 19 depicts an eighteenth example data flow 1900 for mobile wallet operations in a gaming environment. The data flow 1900 may be implemented using the system 100 of FIG. 1.

A user may use a player interface device 1906 (such as a touch screen, keypad, tablet, service window, button, and so on) associated with an electronic gaming machine to send a fund transfer request to a peripheral system 1901. The peripheral system 1901 may then initiate a fund transfer request by communicating with a wireless interface with a peripheral network adapter (PNA) 1904/1905 associated with the electronic gaming machine. The fund transfer request may include a transfer amount specified by the user using the player interface device 1906.

The user may also use a mobile device 1909 to request funds from a player wallet system 1911. The player wallet system 1911 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The request for funds may include a transfer amount specified by the user using the mobile device 1909. The mobile device 1909 may receive an acknowledgement of funds from the player wallet system 1911. The acknowledgement of funds may include information regarding available funds that the mobile device 1909 may use to select to redeem for a funds transfer.

The user may further use a mobile device 1909 to send pairing information to the wireless interface with a peripheral network adapter (PNA) 1904/1905, and the wireless interface with peripheral network adapter (PNA) 1904/1905 may send the pairing information to the peripheral system 1901 and receive a pairing acknowledgment in return. The wireless interface with a peripheral network adapter (PNA) 1904/1905 may send the pairing acknowledgement to the mobile device 1909. The wireless interface with a peripheral network adapter (PNA) 1904/1905 and/or the peripheral system 1901 may store data regarding the pairing in order to associate fund transfers with the appropriate electronic gaming machine and user and/or fund transfer request and/or other associated information.

The user may then use the mobile device 1909 to send transaction information to the wireless interface with a peripheral network adapter (PNA) 1904/1905. The transaction information may include information regarding available funds that the mobile device 1909 was used to select to redeem for a funds transfer. The wireless interface with a peripheral network adapter (PNA) 1904/1905 may send the fund transfer request to a game-crediting process 1920. The game-crediting process 1920 may involve storing transaction status information in the peripheral system 1901, which may update the player wallet system 1911 accordingly based on the funds transfer, and providing a game credited notification indicating that the fund transfer was used to credit the electronic gaming machine to the wireless interface with a peripheral network adapter (PNA) 1904/1905. The peripheral system 1901 may then notify the player interface device 1906 of the transaction status and the wireless interface with a peripheral network adapter (PNA) 1904/1905 may send a transaction notification to the mobile device 1909.

In various examples, this example data flow 1900 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 1900 is illustrated and described as including particular operations performed in a particular order, it is understood that this is an example. In various implementations, various orders of the same, similar, and/or different operations may be performed without departing from the scope of the present disclosure.

For example, the data flow 1900 illustrates and describes the mobile device 1909 communicating with the player wallet system 1911. However, it is understood that this is an example. In some implementations, a peripheral network adapter (PNA) may communicate with a player wallet system instead of a mobile device communicating with the player wallet system. For example, a user may use a mobile device to interface with a peripheral network adapter (PNA) via wireless communication (such as NFC, Bluetooth™, Wi-Fi, and so on). The peripheral network adapter (PNA) may contact a player wallet system and retrieve the user's account information. This account information may include information regarding available funds. The peripheral network adapter (PNA) may then send the information regarding the available funds to the mobile device via a wireless interface. The user may then use the mobile device to select which funds to redeem.

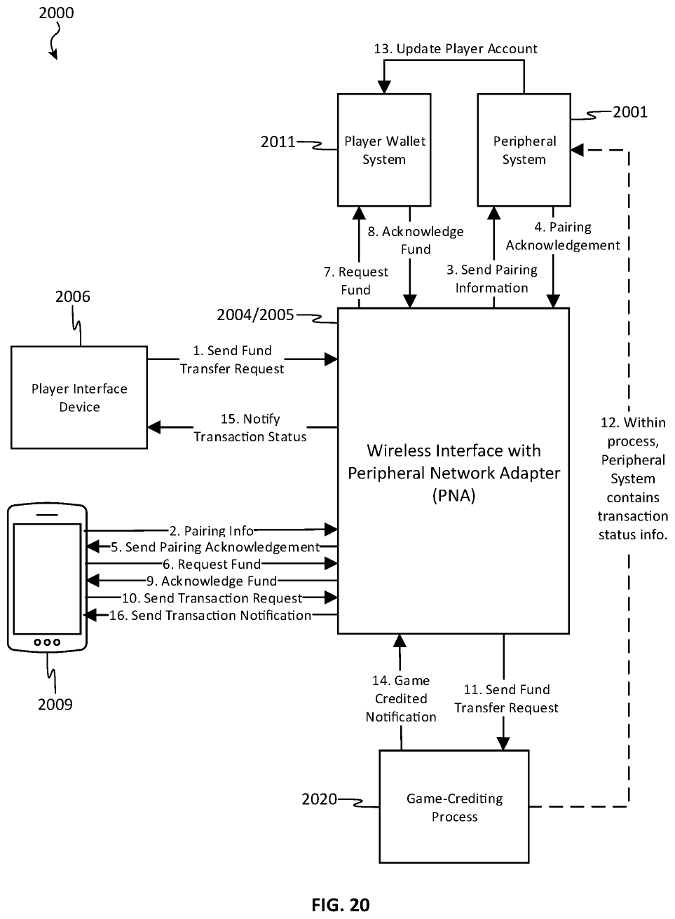

By way of illustration, FIG. 20 depicts a nineteenth example data flow 2000 for mobile wallet operations in a gaming environment. The data flow 2000 may be implemented using the system 100 of FIG. 1.

A user may use a player interface device 2006 (such as a touch screen, keypad, tablet, service window, button, and so on) associated with an electronic gaming machine to send a fund transfer request to a wireless interface with a peripheral network adapter (PNA) 2004/2005 associated with the electronic gaming machine. The fund transfer request may include a transfer amount specified by the user using the player interface device 2006.

The user may also use a mobile device 2009 to send pairing information to the wireless interface with a peripheral network adapter (PNA) 2004/2005, and the wireless interface with peripheral network adapter (PNA) 2004/2005 may send the pairing information to a peripheral system 2001 and receive a pairing acknowledgment in return. The wireless interface with a peripheral network adapter (PNA) 2004/2005 may send the pairing acknowledgement to the mobile device 2009. The wireless interface with a peripheral network adapter (PNA) 2004/2005 and/or the peripheral system 2001 may store data regarding the pairing in order associate fund transfers with the appropriate electronic gaming machine and user and/or fund transfer request and/or other associated information.

The user may then use the mobile device 2009 to send a fund request to the wireless interface with a peripheral network adapter (PNA) 2004/2005, which may send the fund request to a player wallet system 2011. The player wallet system 2011 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The fund request may include a transfer amount specified by the user using the mobile device 2009. The wireless interface with a peripheral network adapter (PNA) 2004/2005 may receive an acknowledgement of funds from the player wallet system 2011, which the wireless interface with a peripheral network adapter (PNA) 2004/2005 may provide to the mobile device 2009. The acknowledgement of funds may include information regarding available funds that the mobile device 2009 may use to select to redeem for a funds transfer.

The user may then use the mobile device 2009 to send a transaction request to the wireless interface with a peripheral network adapter (PNA) 2004/2005. The transaction request may include information regarding available funds that the mobile device 2009 used to select to redeem for a funds transfer. The wireless interface with a peripheral network adapter (PNA) 2004/2005 may send a fund transfer request to a game-crediting process 2020. The game-crediting process 2020 may involve storing transaction status information in the peripheral system 2001, which may update the player wallet system 2011 accordingly based on the funds transfer, and providing a game credited notification indicating that the fund transfer was used to credit the electronic gaming machine to the wireless interface with a peripheral network adapter (PNA) 2004/2005. The wireless interface with a peripheral network adapter (PNA) 2004/2005 may then notify the player interface device 2006 of the transaction status and send a transaction notification to the mobile device 2009.

In various examples, this example data flow 2000 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 2000 is illustrated and described as including particular operations performed in a particular order, it is understood that this is an example. In various implementations, various orders of the same, similar, and/or different operations may be performed without departing from the scope of the present disclosure.

For example, the data flow 2000 illustrates and describes the player interface device 2006 communicating with the wireless interface with a peripheral network adapter (PNA) 2004/2005. However, it is understood that this is an example. In some implementations, a player interface device (such as a touch screen, keypad, tablet, service window, button, and so on) associated with an electronic gaming machine may communicate with a peripheral system instead of a peripheral network adapter (PNA). Various configurations are possible and contemplated without departing from the scope of the present disclosure.

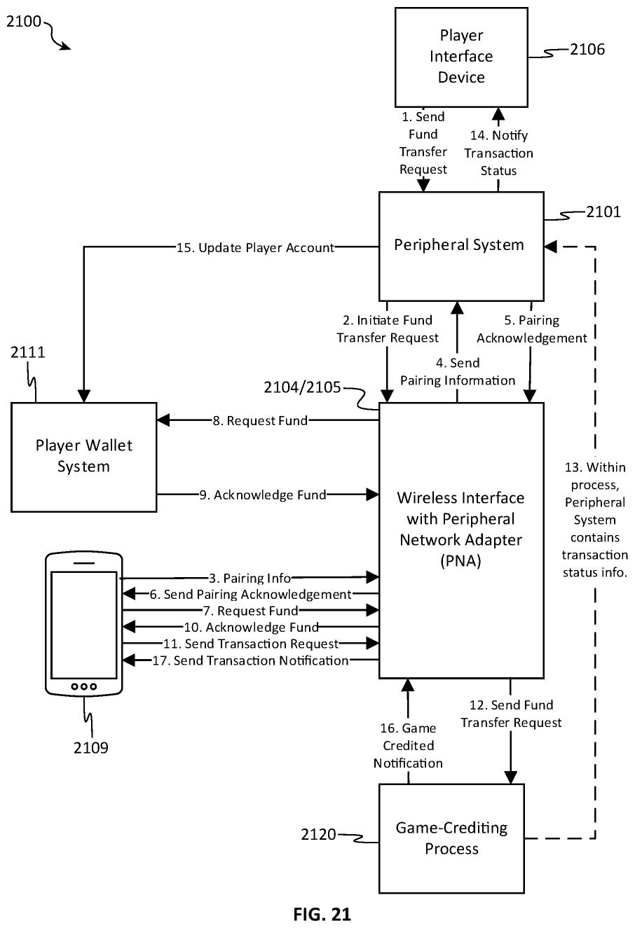

By way of illustration, FIG. 21 depicts a twentieth example data flow 2100 for mobile wallet operations in a gaming environment. The data flow 2100 may be implemented using the system 100 of FIG. 1.

A user may use a player interface device 2106 (such as a touch screen, keypad, tablet, service window, button, and so on) associated with an electronic gaming machine to send a fund transfer request to a peripheral system 2101, which may initiate a fund transfer request by communicating with a wireless interface with a peripheral network adapter (PNA) 2104/2105 associated with the electronic gaming machine. The fund transfer request may include a transfer amount specified by the user using the player interface device 2106.

The user may also use a mobile device 2109 to send pairing information to the wireless interface with a peripheral network adapter (PNA) 2104/2005, and the wireless interface with peripheral network adapter (PNA) 2104/2105 may send the pairing information to the peripheral system 2101 and receive a pairing acknowledgment in return. The wireless interface with a peripheral network adapter (PNA) 2104/2005 may send the pairing acknowledgement to the mobile device 2109. The wireless interface with a peripheral network adapter (PNA) 2104/2105 and/or the peripheral system 2101 may store data regarding the pairing in order to associate fund transfers with the appropriate electronic gaming machine and user and/or fund transfer request and/or other associated information.

The user may then use the mobile device 2109 to send a fund request to the wireless interface with a peripheral network adapter (PNA) 2104/2105, which may send the fund request to a player wallet system 2111. The player wallet system 2111 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The fund request may include a transfer amount specified by the user using the mobile device 2109. The wireless interface with a peripheral network adapter (PNA) 2104/2105 may receive an acknowledgement of funds from the player wallet system 2111, which the wireless interface with a peripheral network adapter (PNA) 2104/2105 may provide to the mobile device 2109. The acknowledgement of funds may include information regarding available funds that the mobile device 2109 may use to select to redeem for a funds transfer.

The user may then use the mobile device 2109 to send a transaction request to the wireless interface with a peripheral network adapter (PNA) 2104/2105. The transaction request may include information regarding available funds that the mobile device 2109 was used to select to redeem for a funds transfer. The wireless interface with a peripheral network adapter (PNA) 2104/2105 may send a fund transfer request to a game-crediting process 2120. The game-crediting process 2120 may involve storing transaction status information in the peripheral system 2101, which may update the player wallet system 2111 accordingly based on the funds transfer, and providing a game credited notification indicating that the fund transfer was used to credit the electronic gaming machine to the wireless interface with a peripheral network adapter (PNA) 2104/2005. The peripheral system 2101 may then notify the player interface device 2106 of the transaction status and the wireless interface with a peripheral network adapter (PNA) 2104/2105 may send a transaction notification to the mobile device 2109.

In various examples, this example data flow 2100 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 2100 is illustrated and described as including particular operations performed in a particular order, it is understood that this is an example. In various implementations, various orders of the same, similar, and/or different operations may be performed without departing from the scope of the present disclosure.

For example, the data flow 2100 illustrates and describes the wireless interface with a peripheral network adapter (PNA) 2104/2105 communicating with the player wallet system 2111. However, it is understood that this is an example. In some implementations, a peripheral system may communicate with a player wallet system instead of a wireless interface with a peripheral network adapter (PNA) and/or a peripheral network adapter (PNA) communicating with the player wallet system. For example, a user may use a mobile device to interface with a peripheral network adapter (PNA) via wireless communication (such as NFC, Bluetooth™, Wi-Fi, and so on). The peripheral network adapter (PNA) may communicate with a peripheral system, which may contact a player wallet system and retrieve the user's account information. This account information may include information regarding available funds. The peripheral network system may then send the information regarding the available funds to the mobile device via the peripheral network adapter (PNA), which may communicate with the mobile device via a wireless interface. The user may then use the mobile device to select which funds to redeem.

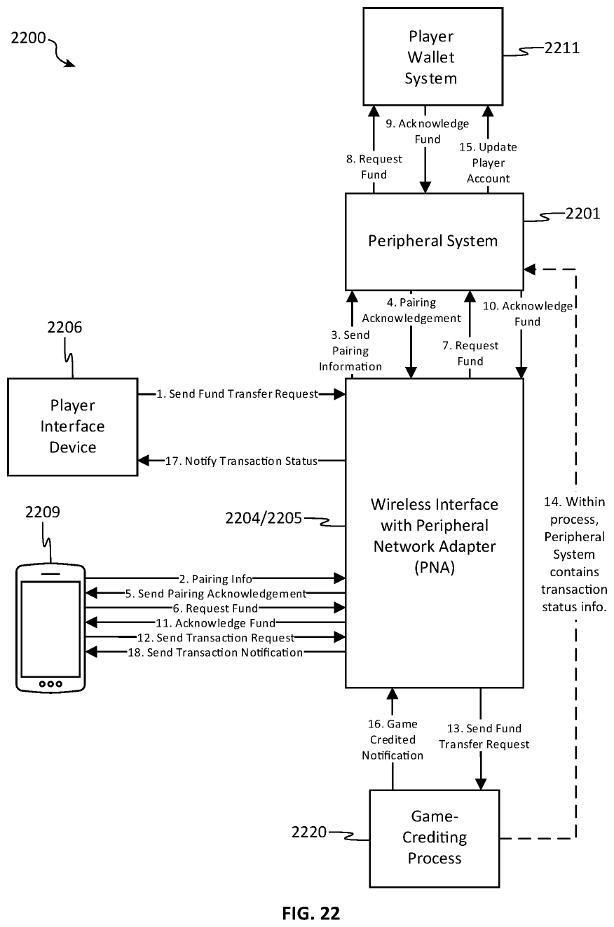

By way of illustration, FIG. 22 depicts a twenty-first example data flow 2200 for mobile wallet operations in a gaming environment. The data flow 2200 may be implemented using the system 100 of FIG. 1.

A user may use a player interface device 2206 (such as a touch screen, keypad, tablet, service window, button, and so on) associated with an electronic gaming machine to send a fund transfer request to a wireless interface with a peripheral network adapter (PNA) 2204/2205 associated with the electronic gaming machine. The fund transfer request may include a transfer amount specified by the user using the player interface device 2206.

The user may also use a mobile device 2209 to send pairing information to the wireless interface with a peripheral network adapter (PNA) 2204/2205, and the wireless interface with peripheral network adapter (PNA) 2204/2205 may send the pairing information to a peripheral system 2201 and receive a pairing acknowledgment in return. The wireless interface with a peripheral network adapter (PNA) 2204/2205 may send the pairing acknowledgement to the mobile device 2209. The wireless interface with a peripheral network adapter (PNA) 2204/2205 and/or the peripheral system 2201 may store data regarding the pairing in order to associate fund transfers with the appropriate electronic gaming machine and user and/or fund transfer request and/or other associated information.

The user may further use the mobile device 2209 to send a fund request to the wireless interface with a peripheral network adapter (PNA) 2204/2205. The wireless interface with a peripheral network adapter (PNA) 2204/2205 may transmit the fund request to the peripheral system 2201, which may provide the fund request to a player wallet system 2211. The player wallet system 2211 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The fund request may include a transfer amount specified by the user using the mobile device 2209. The peripheral system 2201 may receive an acknowledgement of funds from the player wallet system 2211, which the peripheral system 2201 may provide to the wireless interface with a peripheral network adapter (PNA) 2204/2205 and the wireless interface with a peripheral network adapter (PNA) 2204/2205 may in turn provide to the mobile device 2209. The acknowledgement of funds may include information regarding available funds that the mobile device 2209 may use to select to redeem for a funds transfer.

The user may then use the mobile device 2209 to send a transaction request to the wireless interface with a peripheral network adapter (PNA) 2204/2205. The transaction information may include information regarding available funds that the mobile device 2209 used to select to redeem for a funds transfer. The wireless interface with a peripheral network adapter (PNA) 2204/2205 may send the fund transfer request to a game-crediting process 2220. The game-crediting process 2220 may involve storing transaction status information in the peripheral system 2201, which may update the player wallet system 2211 accordingly based on the funds transfer, and providing a game credited notification indicating that the funds transfer was used to credit the electronic gaming machine to the wireless interface with a peripheral network adapter (PNA) 2204/2205. The wireless interface with a peripheral network adapter (PNA) 2204/2205 may then notify the player interface device 2206 of the transaction status and send a transaction notification to the mobile device 2209.

In various examples, this example data flow 2200 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 2200 is illustrated and described as including particular operations performed in a particular order, it is understood that this is an example. In various implementations, various orders of the same, similar, and/or different operations may be performed without departing from the scope of the present disclosure.

For example, the data flow 2200 illustrates and describes the player interface device 2206 communicating with the wireless interface with a peripheral network adapter (PNA) 2204/2205. However, it is understood that this is an example. In some implementations, a player interface device (such as a touch screen, keypad, tablet, service window, button, and so on) associated with an electronic gaming machine may communicate with a peripheral system instead of a peripheral network adapter (PNA). Various configurations are possible and contemplated without departing from the scope of the present disclosure.

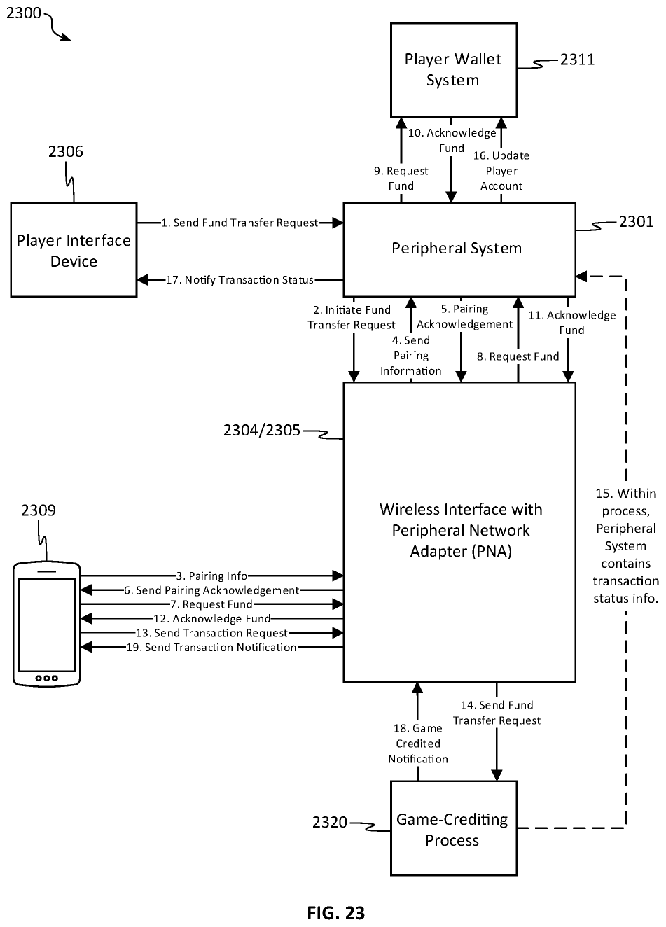

FIG. 23 depicts a twenty-second example data flow 2300 for mobile wallet operations in a gaming environment. The data flow 2300 may be implemented using the system 100 of FIG. 1.

A user may use a player interface device 2306 (such as a touch screen, keypad, tablet, service window, button, and so on) associated with an electronic gaming machine to send a fund transfer request to a peripheral system 2301, which may initiate a fund transfer request by communicating with a wireless interface with a peripheral network adapter (PNA) 2304/2305 associated with the electronic gaming machine. The fund transfer request may include a transfer amount specified by the user using the player interface device 2306.

The user may also use a mobile device 2309 to send pairing information to the wireless interface with a peripheral network adapter (PNA) 2304/2305, and the wireless interface with peripheral network adapter (PNA) 2304/2305 may send the pairing information to the peripheral system 2301 and receive a pairing acknowledgment in return. The wireless interface with a peripheral network adapter (PNA) 2304/2305 may send the pairing acknowledgement to the mobile device 2309. The wireless interface with a peripheral network adapter (PNA) 2304/2305 and/or the peripheral system 2301 may store data regarding the pairing in order to associate fund transfers with the appropriate electronic gaming machine and user and/or fund transfer request and/or other associated information.

The user may further use the mobile device 2309 to send a fund request to the wireless interface with a peripheral network adapter (PNA) 2304/2305. The wireless interface with a peripheral network adapter (PNA) 2304/2305 may transmit the fund request to the peripheral system 2301, which may provide the fund request to a player wallet system 2311. The player wallet system 2311 may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The fund request may include a transfer amount specified by the user using the mobile device 2309. The peripheral system 2301 may receive an acknowledgement of funds from the player wallet system 2311, which the peripheral system 2301 may provide to the wireless interface with a peripheral network adapter (PNA) 2304/2305 and the wireless interface with a peripheral network adapter (PNA) 2304/2305 may in turn provide to the mobile device 2309. The acknowledgement of funds may include information regarding available funds that the mobile device 2309 may use to select to redeem for a funds transfer.

The user may then use the mobile device 2309 to send a transaction request to the wireless interface with a peripheral network adapter (PNA) 2304/2305. The transaction information may include information regarding available funds that the mobile device 2309 used to select to redeem for a funds transfer. The wireless interface with a peripheral network adapter (PNA) 2304/2305 may send the fund transfer request to a game-crediting process 2320. The game-crediting process 2320 may involve storing transaction status information in the peripheral system 2301, which may update the player wallet system 2311 accordingly based on the funds transfer, and providing a game credited notification indicating that the funds transfer was used to credit the electronic gaming machine to the wireless interface with a peripheral network adapter (PNA) 2304/2305. The peripheral system 2301 may then notify the player interface device 2306 of the transaction status and the wireless interface with a peripheral network adapter (PNA) 2304/2305 may send a transaction notification to the mobile device 2309.

In various examples, this example data flow 2300 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example data flow 2300 is illustrated and described as including particular operations performed in a particular order, it is understood that this is an example. In various implementations, various orders of the same, similar, and/or different operations may be performed without departing from the scope of the present disclosure.

For example, the data flow 2300 is illustrated and described as the peripheral system 2301 updating the player wallet system 2311 using transaction information stored in the peripheral system 2301 by the game-crediting process 2320. However, it is understood that this is an example. In some implementations, a game-crediting process may update a player wallet system without storing transaction information in a peripheral system. Various configurations are possible and contemplated without departing from the scope of the present disclosure.

Data flows 200-2300 of FIGS. 2-23 include discussion of one or more game-crediting processes 320-2320. Examples of such processes will now be discussed in detail.

In some examples, one or more game-crediting processes may involve a peripheral network adapter (PNA) crediting an associated electronic gaming machine through an AFT (“automated funds transfer”). In some implementations of such examples, payment information (such as payment information associated with a card payment, a mobile payment, and so on) passes from a peripheral network adapter (PNA) to a peripheral system and then to a payment processing system, which may actually process a payment using the payment information. After the payment has been processed and the funds have been deducted, the peripheral network adapter (PNA) may be notified and may in turn credit the electronic gaming machine with an AFT. Such a configuration may not be applicable to player wallet system transactions.

By way of illustration, FIG. 24 depicts a first example of a game-crediting process 2400 that may be used in mobile wallet operations in a gaming environment. The game-crediting process 2400 may be used in one or more of the data flows 200-2300 of FIGS. 2-23. The game-crediting process 2400 may be performed using the system 100 of FIG. 1.

A peripheral network adapter (PNA) 2404 may transmit a message to a peripheral system 2401 to process a credit card transaction. The message may be based on payment information received by the peripheral network adapter (PNA) 2404. The peripheral system 2401 may send the message to a payment processing system 2412 and receive a transaction confirmation in return. In response, the peripheral system 2401 may send a message regarding funds for crediting to the peripheral network adapter (PNA) 2404, which may credit an associated electronic gaming machine 2403 using AFT.

In various examples, this game-crediting process 2400 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example game-crediting process 2400 is illustrated and described as including particular operations performed in a particular order, it is understood that this is an example. In various implementations, various orders of the same, similar, and/or different operations may be performed without departing from the scope of the present disclosure.

For example, the game-crediting process 2400 is illustrated and described in the context of a card payment transaction. However, it is understood that this is an example. In some implementations, a game-crediting process may instead involve a mobile payment transaction. Various configurations are possible and contemplated without departing from the scope of the present disclosure.

By way of another example, the game-crediting process 2400 is illustrated and described as the peripheral system 2401 acting as an intermediary passing messages between the peripheral network adapter (PNA) 2404 and the payment processing system 2412. However, it is understood that this is an example. In some implementations, a peripheral network adapter (PNA) may communicate directly with a payment processing system instead of via a peripheral system. Various configurations are possible and contemplated without departing from the scope of the present disclosure.

For example, in some implementations, payment information (such as payment information associated with a card payment, a mobile payment, and so on) may pass from a peripheral network adapter (PNA) directly to a payment processing system, which may actually process a payment using the payment information. After the payment has been processed and the funds have been deducted, the peripheral network adapter (PNA) may be notified and then credit the electronic gaming machine with an AFT. Such a configuration may not be applicable to player wallet system transactions.

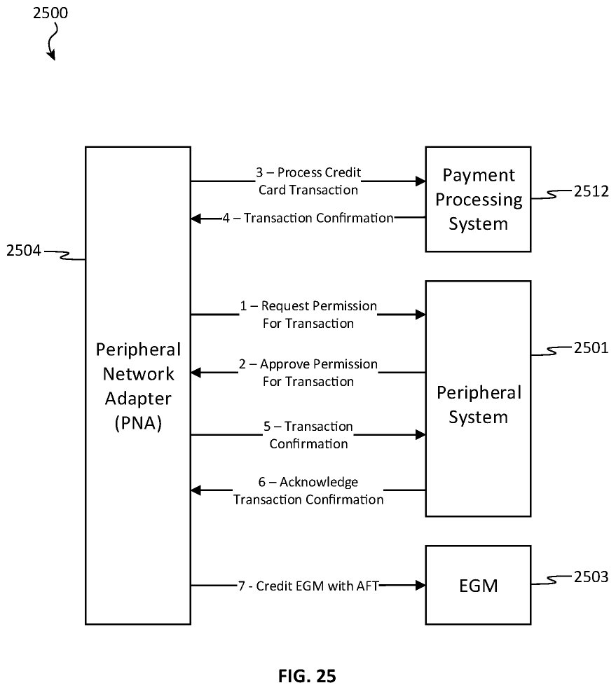

By way of illustration, FIG. 25 depicts a second example of a game-crediting process 2500 that may be used in mobile wallet operations in a gaming environment. The game-crediting process 2500 may be used in one or more of the data flows 200-2300 of FIGS. 2-23. The game-crediting process 2500 may be performed using the system 100 of FIG. 1.

A peripheral network adapter (PNA) 2504 may transmit a request to a peripheral system 2501 for permission related to a credit card transaction. The request may be based on payment information received by the peripheral network adapter (PNA) 2504. The peripheral system 2501 may reply with permission and the peripheral network adapter (PNA) 2504 may transmit a message to a payment processing system 2512 to process the credit card transaction. The peripheral network adapter (PNA) 2504 may receive a transaction confirmation from the payment processing system 2512 and send a transaction confirmation to the peripheral system 2501. The peripheral system 2501 may reply with an acknowledgement of the transaction confirmation and the peripheral network adapter (PNA) 2504 may then credit an associated electronic gaming machine 2503 using AFT.

In various examples, this game-crediting process 2500 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example game-crediting process 2500 is illustrated and described as including particular operations performed in a particular order, it is understood that this is an example. In various implementations, various orders of the same, similar, and/or different operations may be performed without departing from the scope of the present disclosure.

For example, the game-crediting process 2500 is illustrated and described in the context of a card payment transaction. However, it is understood that this is an example. In some implementations, a game-crediting process may instead involve a mobile payment transaction. Various configurations are possible and contemplated without departing from the scope of the present disclosure.

Further, as discussed above, the game-crediting processes 2400 and 2500 may not be applicable to player wallet system transactions. In contexts involving player wallet system transactions, other game-crediting processes may be used.

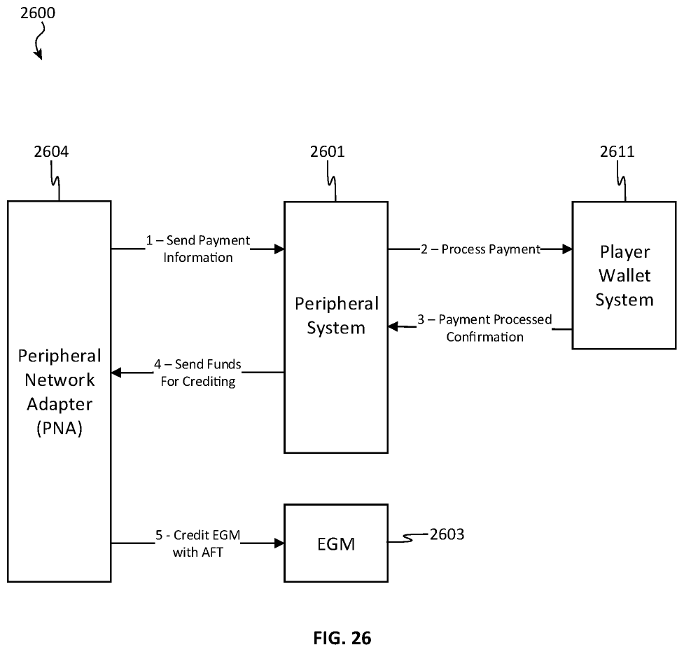

By way of illustration, FIG. 26 depicts a third example of a game-crediting process 2600 that may be used in mobile wallet operations in a gaming environment. The game-crediting process 2600 may be used in one or more of the data flows 200-2300 of FIGS. 2-23. The game-crediting process 2600 may be performed using the system 100 of FIG. 1.

A peripheral network adapter (PNA) 2604 may send payment information to a peripheral system 2601. The message may be related to an account in a player wallet system 2611. The player wallet system may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The peripheral system 2601 may send the payment information to the player wallet system 2611 and receive a confirmation that the payment was processed in return. In response, the peripheral system 2601 may send a message regarding funds for crediting to the peripheral network adapter (PNA) 2604, which may credit an associated electronic gaming machine 2603 using AFT.

In various examples, this game-crediting process 2600 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example game-crediting process 2600 is illustrated and described as including particular operations performed in a particular order, it is understood that this is an example. In various implementations, various orders of the same, similar, and/or different operations may be performed without departing from the scope of the present disclosure.

For example, the game-crediting process 2600 is illustrated and described as using the peripheral network adapter (PNA) 2604 to credit the associated electronic gaming machine 2603 using AFT. However, it is understood that this is an example. In some implementations, a casino management server and/or system may be used to credit an electronic gaming machine associated with a payment. Various configurations are possible.

In various examples, payment information (such as payment information associated with a card payment, a mobile payment, and so on) may pass from a peripheral network adapter (PNA) to a peripheral system and then to a payment processing system, which may actually process a payment using the payment information. After the payment has been processed and the funds have been deducted, a casino management server and/or system may be notified. The casino management server and/or system may then credit the electronic gaming machine. Such a configuration may not be applicable to player wallet system transactions.

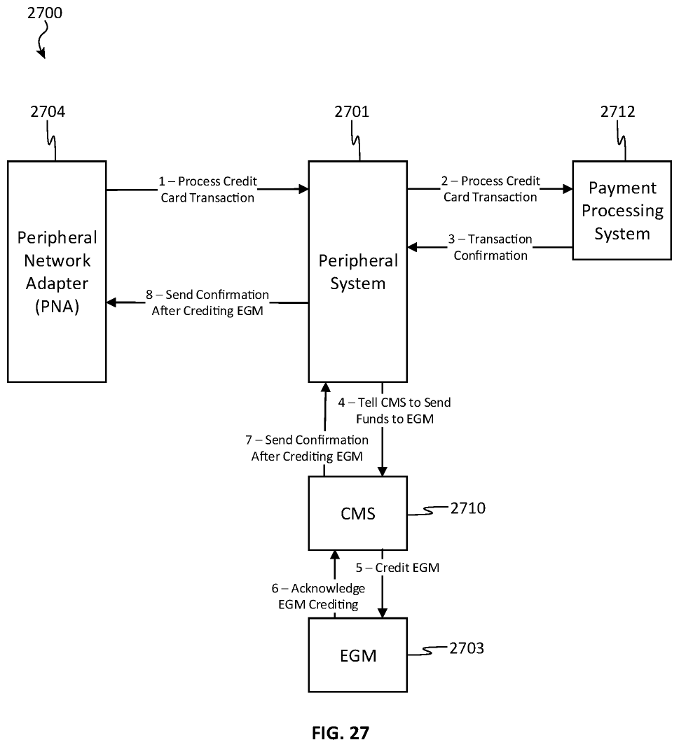

By way of illustration, FIG. 27 depicts a fourth example of a game-crediting process 2700 that may be used in mobile wallet operations in a gaming environment. The game-crediting process 2700 may be used in one or more of the data flows 200-2300 of FIGS. 2-23. The game-crediting process 2700 may be performed using the system 100 of FIG. 1.

A peripheral network adapter (PNA) 2704 may transmit a message to a peripheral system 2401 to process a credit card transaction. The message may be based on payment information received by the peripheral network adapter (PNA) 2704. The peripheral system 2701 may transmit the message to a payment processing system 2712 to process the credit card transaction. The peripheral system 2701 may receive a transaction confirmation from the payment processing system 2712 and instruct a casino management server and/or system 2710 to credit an electronic gaming machine 2703. The casino management server and/or system 2710 may receive an acknowledgment of the crediting from the electronic gaming machine 2703 and send a confirmation to the peripheral system 2701, which may then provide the confirmation to the peripheral network adapter (PNA) 2704.

In various examples, this game-crediting process 2700 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example game-crediting process 2700 is illustrated and described as including particular operations performed in a particular order, it is understood that this is an example. In various implementations, various orders of the same, similar, and/or different operations may be performed without departing from the scope of the present disclosure.

For example, the game-crediting process 2700 is illustrated and described in the context of a card payment transaction. However, it is understood that this is an example. In some implementations, a game-crediting process may instead involve a mobile payment transaction. Various configurations are possible and contemplated without departing from the scope of the present disclosure.

By way of another example, the game-crediting process 2700 is illustrated and described as the peripheral system 2701 acting as an intermediary passing messages between the peripheral network adapter (PNA) 2704 and the payment processing system 2712. However, it is understood that this is an example. In some implementations, a peripheral network adapter (PNA) may communicate directly with a payment processing system instead of via a peripheral system. Various configurations are possible and contemplated without departing from the scope of the present disclosure.

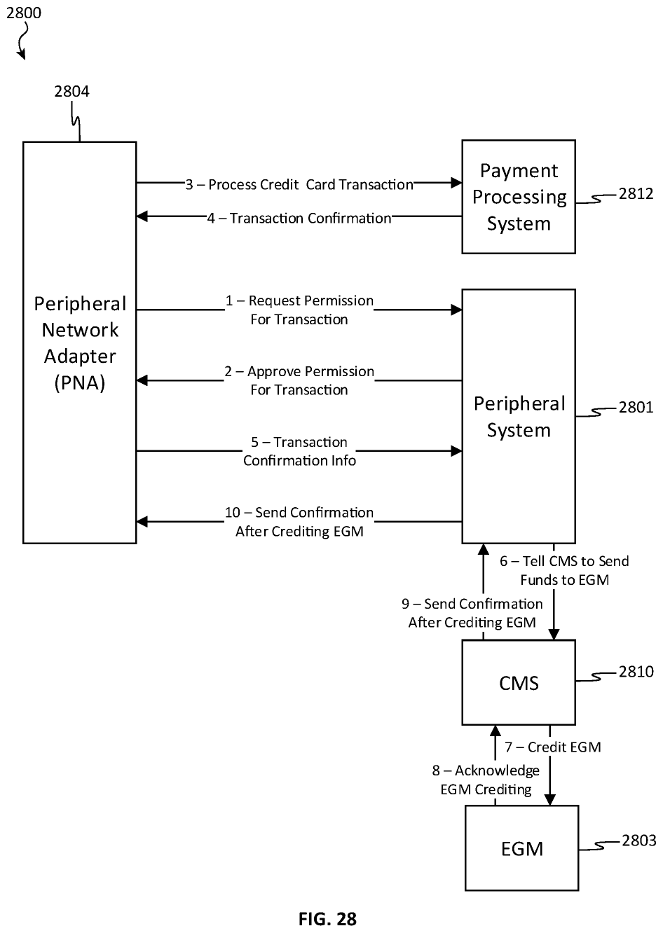

By way of illustration, FIG. 28 depicts a fifth example of a game-crediting process 2800 that may be used in mobile wallet operations in a gaming environment. The game-crediting process 2800 may be used in one or more of the data flows 200-2300 of FIGS. 2-23. The game-crediting process 2800 may be performed using the system 100 of FIG. 1.

A peripheral network adapter (PNA) 2804 may transmit a request to a peripheral system 2801 for permission related to a credit card transaction. The request may be based on payment information received by the peripheral network adapter (PNA) 2804. The peripheral system 2801 may reply with permission and the peripheral network adapter (PNA) 2804 may transmit a message to a payment processing system 2812 to process the credit card transaction. The peripheral network adapter (PNA) 2804 may receive a transaction confirmation from the payment processing system 2512 and send a transaction confirmation to the peripheral system 2801. The peripheral system 2801 may then instruct a casino management server and/or system 2810 to credit an electronic gaming machine 2803. The casino management server and/or system 2810 may receive an acknowledgment of the crediting from the electronic gaming machine 2803 and send a confirmation to the peripheral system 2801, which may then provide the confirmation to the peripheral network adapter (PNA) 2804.

In various examples, this game-crediting process 2800 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example game-crediting process 2800 is illustrated and described as including particular operations performed in a particular order, it is understood that this is an example. In various implementations, various orders of the same, similar, and/or different operations may be performed without departing from the scope of the present disclosure.

For example, the game-crediting process 2800 is illustrated and described in the context of a card payment transaction. However, it is understood that this is an example. In some implementations, a game-crediting process may instead involve a mobile payment transaction. Various configurations are possible and contemplated without departing from the scope of the present disclosure.

Further, as discussed above, the game-crediting processes 2700 and 2800 may not be applicable to player wallet system transactions. In contexts involving player wallet system transactions, other game-crediting processes may be used. In some examples, the player wallet system may store data related to TITO tickets and/or virtual TITO tickets.

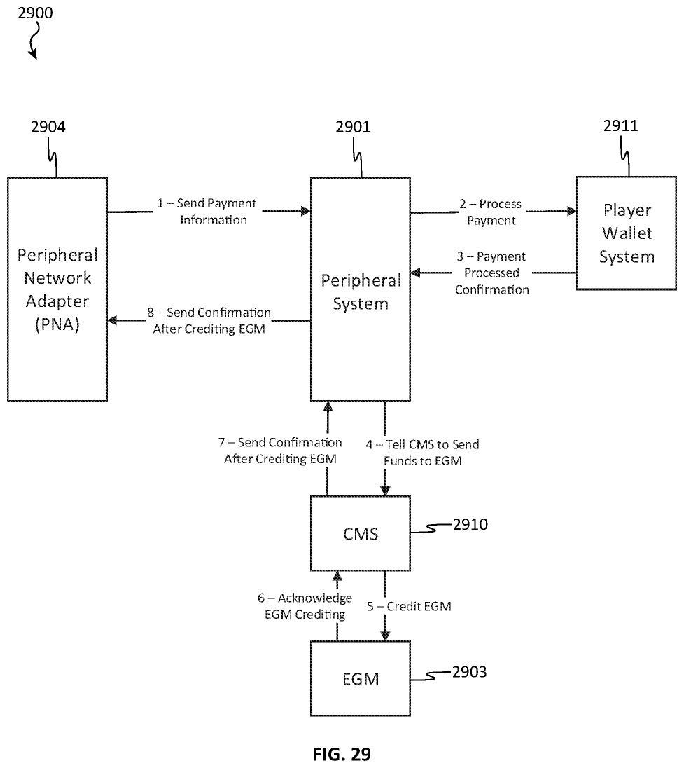

By way of illustration, FIG. 29 depicts a sixth example of a game-crediting process 2900 that may be used in mobile wallet operations in a gaming environment. The game-crediting process 2900 may be used in one or more of the data flows 200-2300 of FIGS. 2-23. The game-crediting process 2900 may be performed using the system 100 of FIG. 1.

A peripheral network adapter (PNA) 2904 may send payment information (such as TITO ticket data and/or virtual TITO ticket and/or other fund information that may be stored in one or more currencies and/or forms) information to a peripheral system 2901. The peripheral system 2901 may communicate with a player wallet system 2911 to process the payment (such as by redeeming the TITO ticket data and/or processing the fund information) and receive a payment processed confirmation (such as a TITO ticket transaction confirmation and/or other fund information processing) in response. The peripheral system 2901 may then instruct a casino management server and/or system 2910 to credit an electronic gaming machine 2903 based on the processed payment information (such as the redeemed TITO ticket data and/or processed fund information). The casino management server and/or system 2910 may receive an acknowledgment of the crediting from the electronic gaming machine 2903 and send a confirmation to the peripheral system 2901, which may then provide the confirmation to the peripheral network adapter (PNA) 2904.

In various examples, this game-crediting process 2900 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example game-crediting process 2900 is illustrated and described as including particular operations performed in a particular order, it is understood that this is an example. In various implementations, various orders of the same, similar, and/or different operations may be performed without departing from the scope of the present disclosure.

For example, the game-crediting process 2900 is illustrated and described as the peripheral system 2901 acting as an intermediary passing messages between the peripheral network adapter (PNA) 2904 and the player wallet system 2911. However, it is understood that this is an example. In some implementations, a peripheral network adapter (PNA) may communicate directly with a player wallet system instead of via a peripheral system. Various configurations are possible and contemplated without departing from the scope of the present disclosure.

Further, the game-crediting process 2900 is illustrated and described in the context of payment information, such as TITO ticket data and/or other fund information that may be stored in one or more currencies and/or forms. However, it is understood that this is an example. In some implementations, a player wallet system may be any kind of system that may be available inside and outside a casino network and may store player and/or other credit in the form of a monetary amount of one or more different types of currency and/or data associated with one or more TITO tickets and/or one or more virtual tickets, such as a bank, a third party and/or other digital wallet, a ticketing wallet or account, and so on. The illustration of an example in the context of payment information, such as TITO ticket data and/or other fund information that may be stored in one or more currencies and/or forms, is not intended to be limiting and other player wallet systems may be used. Various configurations are possible and contemplated without departing from the scope of the present disclosure.

In various implementations, an electronic gaming machine may be credited using a virtual and/or other ticket via a bill validator or other value input device. For example, a peripheral network adapter (PNA) may send payment information (such as payment information related to a card payment transaction, a mobile payment transaction, a player wallet system transaction, and so on) to a peripheral system. If the payment type is a card payment or a mobile payment, the peripheral system may send the payment information to a payment processing system. However, if the payment type is a player wallet system payment, the peripheral system may send the payment information to a player wallet system for processing. After the payment is processed and the funds are deducted, a TITO system may issue data associated with a TITO ticket (and/or a virtual ticket) and the peripheral network adapter (PNA) may use the TITO ticket data to credit an associated electronic gaming machine via an associated bill validator.

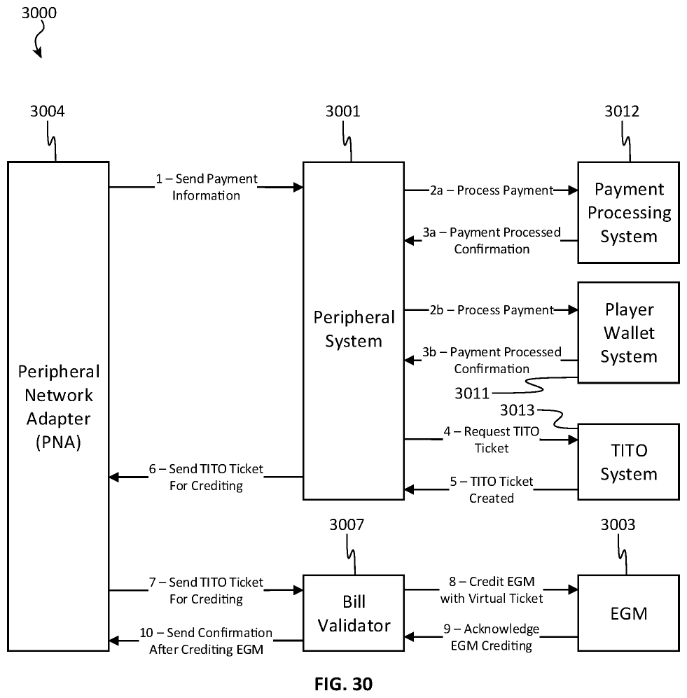

By way of illustration, FIG. 30 depicts a seventh example of a game-crediting process 3000 that may be used in mobile wallet operations in a gaming environment. The game-crediting process 3000 may be used in one or more of the data flows 200-2300 of FIGS. 2-23. The game-crediting process 3000 may be performed using the system 100 of FIG. 1.

A peripheral network adapter (PNA) 3004 may send payment information to a peripheral system 3001. The payment information may be related to a card payment transaction, a mobile payment transaction, a player wallet system transaction, and so on. If the payment type is a card payment or a mobile payment, the peripheral system 3001 may send the payment information to a payment processing system 3012 and receive a payment processed confirmation in response. However, if the payment type is a player wallet system 3011 payment, the peripheral system 3001 may send the payment information to the player wallet system 3011 for processing and receive a payment processed confirmation in response. After the payment is processed and the funds are deducted, the peripheral system 3001 may request TITO ticket data associated with a TITO ticket (and/or a virtual ticket) from a TITO system 3013, which may issue TITO ticket data and/or associated TITO ticket and transmit a notification to the peripheral system 3001 that the TITO ticket data is created. The peripheral system 3001 may then send the TITO ticket data to the peripheral network adapter (PNA) 3004 for crediting, which may send the TITO ticket data to an associated bill validator 3007 for crediting. The bill validator 3007 may credit an associated electronic gaming machine 3003 with the TITO ticket data and receive an acknowledgement of the electronic gaming machine 3003 crediting. The bill validator 3007 may then send a confirmation to the peripheral network adapter (PNA) 3004 regarding the crediting of the electronic gaming machine 3003.

In various examples, this game-crediting process 3000 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example game-crediting process 3000 is illustrated and described as including particular operations performed in a particular order, it is understood that this is an example. In various implementations, various orders of the same, similar, and/or different operations may be performed without departing from the scope of the present disclosure.

For example, the game-crediting process 3000 is illustrated and described as the peripheral system 3001 acting as an intermediary passing messages between the peripheral network adapter (PNA) 3004 and the payment processing system 3012 and/or the player wallet system 3011. However, it is understood that this is an example. In some implementations, a peripheral network adapter (PNA) may communicate directly with a payment processing system and/or a player wallet system instead of via a peripheral system. Various configurations are possible and contemplated without departing from the scope of the present disclosure.

In some implementations, a peripheral network adapter (PNA) may request permission from a peripheral system related to received payment information. Upon receiving permission, the peripheral network adapter (PNA) may determine whether the payment type is a card payment, mobile payment, or a player wallet system payment. If the payment type is a card payment or a mobile payment, the peripheral network adapter (PNA) may send the payment information to a payment processing system for processing. However, if the payment type is a player wallet system payment, the peripheral network adapter (PNA) may send the payment information to a player wallet system for processing. After the payment has been processed and the funds have been deducted, a TITO system may issue TITO ticket data and/or an associated TITO ticket (and/or virtual ticket) and the peripheral network adapter (PNA) may use the TITO ticket data to credit an associated electronic gaming machine via an associated bill validator and/or other value input device.

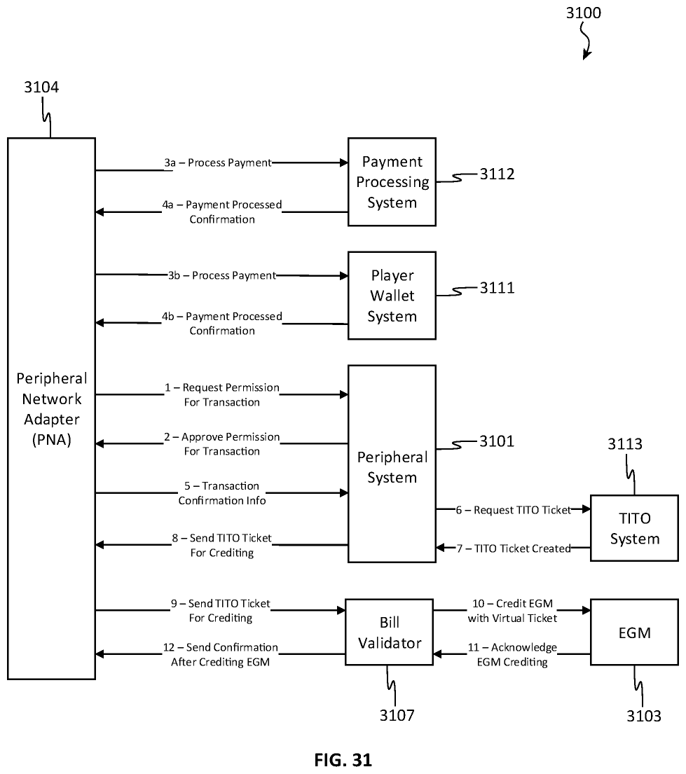

By way of illustration, FIG. 31 depicts an eighth example of a game-crediting process 3100 that may be used in mobile wallet operations in a gaming environment. The game-crediting process 3100 may be used in one or more of the data flows 200-2300 of FIGS. 2-23. The game-crediting process 3100 may be performed using the system 100 of FIG. 1.

A peripheral network adapter (PNA) 3104 may request for permission for a transaction from a peripheral system 3101. The transaction may be related to payment information received by the peripheral network adapter (PNA) 3104. The payment information may be related to a card payment transaction, a mobile payment transaction, a player wallet system transaction, and so on. The peripheral network adapter (PNA) 3104 may receive an approval of permission for the transaction from the peripheral system 3101.

The peripheral network adapter (PNA) 3104 may then determine whether the transaction relates to a card payment transaction, a mobile payment transaction, or a player wallet system transaction. If the payment type is a card payment or a mobile payment, the peripheral network adapter (PNA) 3104 may send the payment information to a payment processing system 3112 and receive a payment processed confirmation in response. However, if the payment type is a player wallet system 3111 payment, the peripheral network adapter (PNA) 3104 may send the payment information to the player wallet system 3111 for processing and receive a payment processed confirmation in response.

After the payment is processed and the funds are deducted, the peripheral network adapter (PNA) 3104 receive a payment processed confirmation in response may send the peripheral system 3101 transaction confirmation information. In response, the peripheral system 3101 may request TITO ticket data associated with a TITO ticket (and/or a virtual ticket) based on the transaction confirmation information from a TITO system 3113, which may issue TITO ticket data and/or an associated TITO ticket and transmit a notification to the peripheral system 3101 that the TITO ticket data is created. The peripheral system 3101 may then send the TITO ticket data to the peripheral network adapter (PNA) 3104 for crediting, which may send the TITO ticket data to an associated bill validator 3107 for crediting. The bill validator 3007 may credit an associated electronic gaming machine 3103 with the TITO ticket data and receive an acknowledgement of the electronic gaming machine 3103 crediting. The bill validator 3107 may then send a confirmation to the peripheral network adapter (PNA) 3104 regarding the crediting of the electronic gaming machine 3103.

In various examples, this game-crediting process 3100 may be implemented using a group of interrelated software modules or components that perform various functions discussed herein. These software modules or components may be executed within a cloud network and/or by one or more computing devices and/or systems involving such computing devices, such as the peripheral system 101, the peripheral network adapter (PNA) 104, the wireless interface 105, the electronic gaming machine 103, the mobile device 109, the mobile payment 114 system, the casino management server 110, the player wallet system 111, the payment processing system 112, and/or the TITO system 113 of FIG. 1.

Although the example game-crediting process 3100 is illustrated and described as including particular operations performed in a particular order, it is understood that this is an example. In various implementations, various orders of the same, similar, and/or different operations may be performed without departing from the scope of the present disclosure.

For example, the game-crediting process 3100 is illustrated and described as the peripheral system 3101 acting as an intermediary passing messages between the peripheral network adapter (PNA) 3104 and the TITO system 3113. However, it is understood that this is an example. In some implementations, a peripheral network adapter (PNA) may communicate directly with a TITO system instead of via a peripheral system. Various configurations are possible and contemplated without departing from the scope of the present disclosure.

In various implementations, a system for electronic payment operations in a gaming environment may include an electronic gaming machine, a bill validator associated with the electronic gaming machine, a peripheral network adapter that is associated with the electronic gaming machine and configured to wirelessly receive payment information from at least one mobile device, and a peripheral system. The peripheral system may be configured to: receive the payment information from the peripheral network adapter; when the payment information relates to a card payment transaction or a mobile payment transaction, communicate with a payment processing system to process a payment; when the payment information relates to a player wallet system transaction, communicate with a player wallet system to process the payment; and upon processing of the payment, send ticket in/ticket out (TITO) ticket data to the peripheral network adapter obtained from a TITO system. The peripheral network adapter may send the TITO ticket data to the bill validator to credit the electronic gaming machine.

In some examples, the peripheral system may determine whether the payment information relates to the card payment transaction, the mobile payment transaction, or the player wallet system transaction. In various examples, the peripheral system may be configured to pair the at least one mobile device with at least one of the peripheral network adapter or the electronic gaming machine using pairing information received by the peripheral network adapter from the at least one mobile device.

In a number of examples, the peripheral system may process the payment for a preset amount. In some examples, the peripheral system may process the payment for an amount specified via the at least one mobile device. In various examples, the peripheral system may process the payment for an amount specified via a player interface device associated with the electronic gaming machine. In a number of such examples, the peripheral system may receive the amount specified via the player interface device. The peripheral system may receive the amount specified via the player interface device from the peripheral network adapter, directly from the player interface device, and so on. The player interface device may be a keypad, a tablet device, a terminal, and/or any kind of device that a user may use to input the amount.

In some implementations, a system for electronic payment operations in a gaming environment may include an electronic gaming machine, a bill validator associated with the electronic gaming machine, a peripheral system, and a peripheral network adapter. The peripheral network adapter may be associated with the electronic gaming machine and configured to: wirelessly receive payment information from at least one mobile device; when the payment information relates to a card payment transaction or a mobile payment transaction, communicate with a payment processing system to process a payment; when the payment information relates to a player wallet system transaction, communicate with a player wallet system to process the payment; upon processing of the payment, obtain ticket in/ticket out (TITO) ticket data from a TITO system via the peripheral system; and send the TITO ticket data to the bill validator to credit the electronic gaming machine.

In various examples, the at least one mobile device may be a first mobile device and a second mobile device. In some such examples, the first mobile device may be a payment card and the second mobile device may be at least one of a mobile phone, a tablet computing device, a laptop computing device, a wearable device, or a smart watch. In some such configurations, the peripheral network adapter may wirelessly receive the payment information from the payment card. In other such configurations, the peripheral network adapter may wirelessly receive the payment information from the payment card via the second mobile device.

In some examples, at least one of the player wallet system may store funds in one or more currencies and/or forms and at least one of the peripheral system or the peripheral network adapter may obtain information regarding the funds via the player wallet system or the TITO ticket data is stored in the player wallet system and at least one of the peripheral system or the peripheral network adapter may obtain the TITO ticket data from the TITO system via the player wallet system. In various examples, the peripheral network adapter may determine whether the payment information relates to the card payment transaction, the mobile payment transaction, or the player wallet system transaction.

In a number of embodiments, a system for electronic payment operations in a gaming environment may include an electronic gaming machine and a peripheral network adapter. The peripheral network adapter may be associated with the electronic gaming machine and configured to: wirelessly receive payment information from at least one mobile device; when the payment information relates to a card payment transaction or a mobile payment transaction, communicate with a payment processing system to process a payment; when the payment information relates to a player wallet system transaction, communicate with a player wallet system to process the payment; and upon processing of the payment, credit the electronic gaming machine.

In various examples, the peripheral network adapter may communicate with the payment processing system via a peripheral system. In some examples, the peripheral network adapter may communicate with the player wallet system via a peripheral system. In a number of examples, the peripheral network adapter may request permission from a peripheral system before processing the payment.

In some examples, the peripheral network adapter may credit the electronic gaming machine using an automated funds transfer. In various examples, the peripheral network adapter may credit the electronic gaming machine by at least one of communicating with a casino management system via a peripheral system, communicating directly with communicating with the casino management system, or by sending TITO ticket data to a bill validator.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to architectures for mobile wallet and other electronic operations in a gaming environment. A system for mobile wallet operations in a gaming environment includes a peripheral system, a peripheral network adapter associated with an electronic gaming machine, and a wireless interface (such as a standalone device, a component of the peripheral network adapter, and/or other device operable to perform functions such as interfacing with a user's phone, payment card, or the like). In some examples, the system may receive payment information from one or more mobile devices; communicate with a payment processing system to process a payment when the payment information relates to a card payment transaction or a mobile payment transaction; communicate with a player wallet system to process the payment when the payment information relates to a player wallet system transaction; and credit the electronic gaming machine. In various examples, the system may credit the electronic gaming machine by sending TITO ticket data to a bill validator associated with the electronic gaming machine, by sending an automated funds transfer to the electronic gaming machine, by having a casino management server and/or system credit the electronic gaming machine, and so on.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A system for electronic payment operations in a gaming environment, comprising:
an electronic gaming machine;
a bill validator associated with the electronic gaming machine;
a peripheral network adapter that is associated with the electronic gaming machine and configured to wirelessly receive payment information from at least one mobile device; and
a peripheral system that is configured to:
receive the payment information from the peripheral network adapter;
when the payment information relates to a card payment transaction or a mobile payment transaction, communicate with a payment processing system to process a payment;
when the payment information relates to a player wallet system transaction, communicate with a player wallet system to process the payment; and
upon processing of the payment, send ticket in/ticket out (TITO) ticket data to the peripheral network adapter obtained from a TITO system; wherein:
the peripheral network adapter sends the TITO ticket data to the bill validator to credit the electronic gaming machine.

2. The system for electronic payment operations in the gaming environment of claim 1, wherein the peripheral system determines whether the payment information relates to the card payment transaction, the mobile payment transaction, or the player wallet system transaction.

3. The system for electronic payment operations in the gaming environment of claim 1, wherein the peripheral system is configured to pair the at least one mobile device with at least one of the peripheral network adapter or the electronic gaming machine using pairing information received by the peripheral network adapter from the at least one mobile device.

4. The system for electronic payment operations in the gaming environment of claim 1, wherein the peripheral system processes the payment for a preset amount.

5. The system for electronic payment operations in the gaming environment of claim 1, wherein the peripheral system processes the payment for an amount specified via the at least one mobile device.

6. The system for electronic payment operations in the gaming environment of claim 1,
wherein the peripheral system processes the payment for an amount specified via a player interface device associated with the electronic gaming machine.

7. The system for electronic payment operations in the gaming environment of claim 6, wherein the peripheral system receives the amount specified via the player interface device.

8. A system for electronic payment operations in a gaming environment, comprising:
an electronic gaming machine;
a bill validator associated with the electronic gaming machine;
a peripheral system; and
a peripheral network adapter that is associated with the electronic gaming machine and configured to:
wirelessly receive payment information from at least one mobile device;
when the payment information relates to a card payment transaction or a mobile payment transaction, communicate with a payment processing system to process a payment;
when the payment information relates to a player wallet system transaction, communicate with a player wallet system to process the payment;
upon processing of the payment, obtain ticket in/ticket out (TITO) ticket data from a TITO system via the peripheral system; and
send the TITO ticket data to the bill validator to credit the electronic gaming machine.

9. The system for electronic payment operations in the gaming environment of claim 8, wherein the at least one mobile device comprises a first mobile device and a second mobile device.

10. The system for electronic payment operations in the gaming environment of claim 9, wherein:
the first mobile device comprises a payment card; and
the second mobile device comprises at least one of a mobile phone, a tablet computing device, a laptop computing device, a wearable device, or a smart watch.

11. The system for electronic payment operations in the gaming environment of claim 10, wherein the peripheral network adapter wirelessly receives the payment information from the payment card.

12. The system for electronic payment operations in the gaming environment of claim 10, wherein the peripheral network adapter wirelessly receives the payment information from the payment card via the second mobile device.

13. The system for electronic payment operations in the gaming environment of claim 8, wherein at least one of:
the player wallet system stores funds in one or more currencies and/or forms and at least one of the peripheral system or the peripheral network adapter obtains information regarding the funds via the player wallet system; or
the TITO ticket data is stored in the player wallet system and at least one of the peripheral system or the peripheral network adapter obtains the TITO ticket data from the TITO system via the player wallet system.

14. The system for electronic payment operations in the gaming environment of claim 8, wherein the peripheral network adapter determines whether the payment information relates to the card payment transaction, the mobile payment transaction, or the player wallet system transaction.

15-20. (canceled)
